(19) United States
(12) Patent Application Publication
(10) Pub. No.: US 2013/0210836 A1
(43) Pub. Date: Aug. 15, 2013

(54) MICROBICIDES

(71) Applicants: Carla Bobbio, Stein (CH); Camilla Corsi, Stein (CH); Stephane Andre Marie Jeanmart, Stein (CH); Sebastian Volker Wenderborn, Stein (CH)

(72) Inventors: Carla Bobbio, Stein (CH); Camilla Corsi, Stein (CH); Stephane Andre Marie Jeanmart, Stein (CH); Sebastian Volker Wenderborn, Stein (CH)

(73) Assignee: SYNGENTA CROP PROTECTION LLC, Greensboro, NC (US)

(21) Appl. No.: 13/810,980

(22) PCT Filed: Jul. 19, 2011
(86) PCT No.: PCT/EP11/62293

§ 371 Date: Apr. 30, 2013

(30) Foreign Application Priority Data
Jul. 19, 2010 (EP) 10169993.2

(51) Int. Cl. A01N 43/80; A01N 43/54; A01N 43/60; A01N 43/40

(52) U.S. Cl. CPC A01N 43/80; A01N 43/40; A01N 43/54; A01N 43/60
USPC 514/255.05; 546/272.1; 514/340; 546/271.1; 514/342; 546/280.4; 514/336; 544/333; 514/256; 544/405

(57) ABSTRACT

The present invention relates to a compound of formula (I): wherein the substituents have the definitions as defined in claim 1 or a salt or a N-oxide thereof, their use and methods for the control and/or prevention of microbial infection, particularly fungal infection, in plants and to processes for the preparation of these compounds.

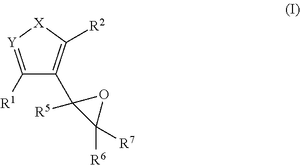

The present invention relates to novel oxirane moieties containing compounds, especially 3-oxiranyl-furan moieties containing compounds, 4-oxiranyl-isoxazole moieties containing compounds, 4-oxiranyl-isothiazole moieties containing compounds and/or 2-thiophen-3-yl-oxirane moieties containing compounds, their use in compositions and methods for the control and/or prevention of microbial infection, particularly fungal infection, in plants and to processes for the preparation of these compounds.

The incidence of serious microbial infections, particularly fungal infections, either systemic or topical, continues to increase for plants.

Fungicides are compounds, of natural or synthetic origin, which act to protect plants against damage caused by fungi. Current methods of agriculture rely heavily on the use of fungicides. In fact, some crops cannot be grown usefully without the use of fungicides. Using fungicides allows a grower to increase the yield of the crop and consequently, increase the value of the crop. Numerous fungicidal agents have been developed. However, the treatment of fungal infestations continues to be a major problem. Furthermore, fungicide resistance has become a serious problem, rendering these agents ineffective for some agricultural uses. As such, a need exists for the development of new fungicidal compounds.

The present invention accordingly relates to compounds of formula (I)

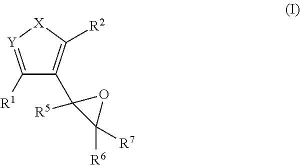

wherein
X is S or O;
Y is C—H or N;
R¹ is unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; or a substituted 5 to 10-membered aromatic heterocycle;
R² is H; halogen, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₁₋₈haloalkyl; substituted C₁₋₈haloalkyl; unsubstituted C₃₋₈cycloalkyl; substituted C₃₋₈cycloalkyl; unsubstituted C₇₋₁₅arylalkyl; substituted C₇₋₁₅arylalkyl; unsubstituted C₆₋₁₀aryloxy-C₁₋₈alkyl; substituted C₆₋₁₀aryloxy-C₁₋₈alkyl; unsubstituted C₆₋₁₀arylthio-C₁₋₈alkyl; substituted C₆₋₁₀arylthio-C₁₋₈alkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; a substituted 5 to 10-membered aromatic heterocycle; unsubstituted C₁₋₈alkylsilyl; or substituted C₁₋₈alkylsilyl;
R⁵ is a unsubstituted 5 to 10 membered aromatic heterocycle; or a substituted 5 to 10 membered aromatic heterocycle;
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; a unsubstituted 5 to 10 membered aromatic heterocycle; or a substituted 5 to 10 membered aromatic heterocycle;

Unless otherwise stated, the substituents R¹, R², R⁵, R⁶ and R⁷ are unsubstituted or substituted, preferably the substituents are unsubstituted or substituted by the substituents given below.

The alkyl groups, the alkenyl groups, the alkynyl groups and the alkoxy groups in the compound of formula (I) are either linear or branched. Halogen signifies preferably F, Cl, Br, I, and more preferred halogen signifies F or Cl.

The preferred substituents of the substituted alkyl groups, the substituted alkenyl groups, the substituted alkynyl groups, the substituted alkoxy groups, substituted aryl groups and/or the aromatic heterocycle groups in the compound of formula (I) are selected from the following substituents F, Cl, Br, I, —OH, —CN, nitro, —C₁₋₄alkoxy, —C₁₋₄alkylthio, Cl₁₋₄alkyl, C₂₋₄alkenyl, C₂₋₄alkenyl, C₂₋₄alkynyl, —C(O)H, —C(O)(C₁₋₄ alkyl), —C(O)(C₁₋₄ alkoxy), —C(O)NH₂, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄ alkyl)₃, —Si(C₁₋₄ alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₂₋₆alkynyl, —C₂₋₆alkenyl, heteroarylC₂₋₆alkynyl, —C₂₋₆alkenyl, C₃₋₈cycloalkyl; —NR⁸R⁹ where R⁸ and R⁹ are independently H, —C₁₋₄alkyl-C₂₋₄alkenyl, —C₂₋₄alkynyl or combine with the interjacent nitrogen to form a five- or six-membered ring which may comprise one or two or three heteroatoms (one or two N, O or S atoms in addition to the interjacent nitrogen atom), in which case the heterocyclic ring is unsubstituted or the heterocyclic ring is substituted by one or two C₁₋₄ alkyl groups, —C₂₋₄alkenyl or substituted —C₂₋₄alkenyl, —C₂₋₄alkynyl or substituted —C₂₋₄alkynyl, —C(O)H, —C(O)(C₁₋₄ alkyl), —C(O)(C₁₋₄ alkoxy), —C(O)NH₂, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄ alkyl)₃, —Si(C₁₋₄ alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₁₋₄ alkynyl, —C₁₋₆alkynyl, wherein all the alkyl, alkenyl, alkynyl, alkoxy, aryl, aryloxy, arylthio or heteroaryl groups are either substituted or unsubstituted, preferably these substituents of the substituted groups bear only one further substituent, more preferably these substituents of the substituted groups are not further substituted.

The more preferred substituents of the substituted alkyl groups, alkenyl groups, the alkynyl groups and the alkoxy are selected from the following substituents —OH, CN, F, Cl, C₁₋₄alkoxy, —C₁₋₄alkylthio, Cl₁₋₄alkyl, C₂₋₄alkenyl, C₂₋₄alkenyl, C₂₋₄alkinyl, C₆₋₁₀aryl, —C₁₋₄alkylamino, more preferably-OH, CN, F, Cl, C₁₋₄alkoxy, Cl₁₋₄alkylamino, -phenyl, -phenyl substituted by Cl or F, —CF₃. The alkyl groups are branched or linear. The most preferred alkyl groups are methyl, ethyl, propyl, iso-propyl, n-butyl, t-butyl (1,1-diemthylethyl), sec-butyl (1-methylpropyl), iso-butyl (2-methylpropyl), pentyl, iso-pentyl (3-methylbutyl, isoamyl), 1-methylpentyl, 1-ethylpentyl, hexyl, heptyl, or octyl. Preferred alkenyl groups are ethenyl, propenyl (1-propenyl, 2-propenyl), butenyl (1-butenyl, 2-butenyl, 3-butenyl, 2-methylpropen-1-yl, 2-methylpropen-2-yl), pentenyl (pent-1-enyl, pent-2-enyl, pent-3-enyl, 2-methylbut-1-enyl, 3-methylbut-1-enyl, 2-methylbut-2-enyl, 3-methylbut-2-enyl, 2-methylbut-3-enyl, 3-methylbut-3-enyl, 1,2-dimethylprop-2-enyl, 1,1-dimethylprop-2-enyl). Preferred alkynyl groups are ethinyl, propinyl (prop-1-inyl or prop-2-inyl (propargyl)), butyl (but-1-ynyl, but-2-ynyl, but-3-ynyl), pentinyl (pent-1-inyl, pent-2-inyl, pent-3-inyl, pent-4-yl, 3-methylbut-1-inyl, 2-methylbut-3-inyl, 1-methylbut-3-inyl). The most preferred alkyl groups and the most preferred alkoxy groups are methyl, ethyl, propyl, t-butyl, methoxy and ethoxy groups. Methyl, ethyl and methoxy groups are very particularly preferred.

Preferably the alkyl groups in the compound of formula (I) and/or the alkoxy groups in the compound of formula (I) bear not more than two further substituents, more preferably the alkyl groups in the compound of formula (I) and/or the alkoxy groups in the compound of formula (I) bear not more than one further substituent, most preferred the alkyl groups in the compound of formula (I) and/or the alkoxy groups in the compound of formula (I) are not further substituted.

Haloalkyl groups (either alone or as part of a larger group, such as haloalkoxy) are alkyl groups which are substituted by one or more of the same or different halogen atoms and are, for example, trifluoromethyl, chlorodifluoromethyl, 2,2,2-trifluoro-ethyl or 2,2-difluoro-ethyl.

Haloalkenyl groups are alkenyl groups, respectively, which are substituted with one or more of the same or different halogen atoms and are, for example, 2,2-difluorovinyl or 1,2-dichloro-2-fluoro-vinyl.

Haloalkynyl groups are alkynyl groups, respectively, which are substituted with one or more of the same or different halogen atoms and are, for example, 1-chloro-prop-2-ynyl.

The preferred substituents of the substituted aryl groups in the compound of formula (I) are selected from the following substituents F, Cl, CF₃, CN, —OH, nitro, —C₁₋₄ alkyl, —C₁₋₄ alkoxy, —C(O)(C₁₋₄ alkoxy), —C(O)H, —C(O)(C₁₋₄ Alkyl) wherein the alkyl groups are either substituted or unsubstituted. In the context of the present specification the term “aryl” refers to a ring system which may be mono-, bi- or tricyclic. Examples of such rings include phenyl or naphthalenyl, antharcenyl or phenanthrenyl. The aryl groups are preferably phenyl groups.

The more preferred substituents of the substituted aryl groups in the compound of formula (I) are selected from the following substituents, F, Cl, —C₁₋₄Alkyl, C₁₋₄alkoxy, —CN, —C(O)(C₁₋₄ alkoxy), —C(O)(C₁₋₄ Alkyl) and preferably F, Cl are the even more preferred substituents of the substituted aryl groups in the compound of formula (I).

The preferred substituents of the substituted heteroaryl groups (aromatic heterocycle) in the compound of formula (I) are selected from the following substituents F, Cl, CF₃, CN, —OH, nitro, —C₁₋₄alkyl, —C₁₋₄alkoxy, —C(O)(C₁₋₄ alkoxy), —C(O)H, —C(O)(C₁₋₄ Alkyl) wherein the alkyl groups are either substituted or unsubstituted. The term “heteroaryl” refers to an aromatic ring system containing at least one heteroatom and consisting either of a single ring or of two or more fused rings. Preferably, single rings will contain up to three heteroatoms and bicyclic systems up to four heteroatoms which will preferably be chosen from nitrogen, oxygen and sulfur. Examples of (5-6 membered) monocyclic groups include pyridyl, pyridazinyl, pyrimidinyl, pyrazinyl, pyrrolyl, pyrazolyl, imidazolyl, triazolyl, tetrazolyl, furanyl, thiophenyl, oxazolyl, isoxazolyl, oxadiazolyl, thiazolyl, isothiazolyl, and thiadiazolyl. Examples of bicyclic groups include quinolinyl, isoquinolinyl, cinnolinyl, quinoxalinyl, benzimidazolyl, benzothiophenyl, and benzothiadiazolyl. Monocyclic heteroaryl groups are preferred, preferably monocyclic rings containing 1 to 3 heterotoms selected from O, N or S, e.g. pyridyl, pyridazinyl, pyrimidinyl, pyrazinyl, pyrazolyl, furanyl, thiophenyl, oxazolyl, isoxazolyl, thiazolyl, preferably pyridyl, pyrazolyl, furanyl, thiophenyl, thiazolyl, pyridyl; and pyrimidinyl, pyridyl, quinolinyl and isoquinolinyl are even more preferred, while pyrimidinyl, pyridyl being most preferred.

The heteroaryl groups are preferably 5 to 6 membered aromatic heterocycle, more preferably 6 membered aromatic heterocycle.

The more preferred substituents of the substituted heteroaryl groups (aromatic heterocycle) in the compound of formula (I) are selected from the following substituents, F, Cl, —C₁₋₄Alkyl, C₁₋₄alkoxy, —CN, —C(O)(C₁₋₄ alkoxy), —C(O)(C₁₋₄ Alkyl) and preferably F, Cl are the even more preferred substituents of the substituted heteroaryl groups in the compound of formula (I). The heteroaryl groups are more preferanly 6 membered aromatic heterocycle. Most preferably the heteroaryl groups are unsubstituted; particularly unsubstituted pyridyl or pyrimidyl preferably a unsubstituted 3-pyridyl or 5-pyrimidyl.

Preferred values of X, Y, R¹, R², R⁵, R⁶ and R⁷ are, in any combination, as set out below.

R¹ is in a preferred embodiment unsubstituted C₃₋₈cycloalkyl; substituted C₃₋₈cycloalkyl; unsubstituted C₆₋₁₀aryl; substituted C₆₋₁₀aryl; unsubstituted C₆₋₁₀aryloxy; substituted C₆₋₁₀aryloxy; a unsubstituted 5 to 10-membered aromatic heterocycle; a substituted 5 to 10-membered aromatic heterocycle;
R¹ is preferably unsubstituted C₆₋₁₀aryl; substituted C₆₋₁₀aryl;
R¹ is more preferred unsubstituted phenyl; phenyl substituted by Cl, F;
R¹ is even more preferred unsubstituted C₁₋₈alkyl; substituted C₁₋₈alkyl; unsubstituted C₁₋₈alkenyl; substituted C₁₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; or a substituted 5 to 10-membered aromatic heterocycle;
R² is in a preferred embodiment H; halogen, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₁₋₈haloalkyl; substituted C₁₋₈haloalkyl; unsubstituted C₃₋₈cycloalkyl; substituted C₃₋₈cycloalkyl; unsubstituted C₇₋₁₅arylalkyl; substituted C₇₋₁₅arylalkyl; unsubstituted C₆₋₁₀aryloxy-C₁₋₈alkyl; substituted C₆₋₁₀aryloxy-C₁₋₈alkyl; unsubstituted C₆₋₁₀arylthio-C₁₋₈alkyl; substituted C₆₋₁₀arylthio-C₁₋₈alkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; a substituted 5 to 10-membered aromatic heterocycle; unsubstituted C₁₋₈alkylsilyl; or substituted C₁₋₈alkylsilyl;
R² is preferrably unsubstituted C₁₋₈alkyl; substituted C₁₋₈alkyl; unsubstituted C₃₋₈cycloalkyl; substituted C₃₋₈cycloalkyl; unsubstituted C₆₋₁₀aryl; substituted C₆₋₁₀aryl; a unsubstituted 5 to 10-membered aromatic heterocycle; a substituted 5 to 10-membered aromatic heterocycle;
R² is more preferred unsubstituted C₃₋₈cycloalkyl; substituted C₃₋₈cycloalkyl; unsubstituted C₆₋₁₀aryl; substituted C₆₋₁₀aryl;

R² is even more preferred unsubstituted cyclohexyl; unsubstituted phenyl; phenyl substituted by Cl, F;

R⁵ is in a preferred embodiment a unsubstituted 5 to 6 membered aromatic heterocycle; or a substituted 5 to 6 membered aromatic heterocycle;
R⁵ is preferrably a unsubstituted 6 membered aromatic heterocycle comprising one or two nitrogen atoms; or a substituted 6 membered aromatic heterocycle comprising one or two nitrogen atoms;
R⁵ is more preferred a unsubstituted pyridyl or pyrimidyl; or a substituted pyridyl or pyrimidyl; preferably a unsubstituted pyridyl or pyrimidyl R⁵ is even more preferred unsubstituted pyridyl or pyrimidyl preferably a unsubstituted 3-pyridyl or 5-pyrimidyl;
R⁶ and R⁷ are in a preferred embodiment independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl;
R⁶ and R⁷ preferrably are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; preferably R⁶ and R⁷ are independently H, unsubstituted C₁₋₈alkyl; substituted C₁₋₈alkyl;
R⁶ and R⁷ more preferred are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; preferably R⁶ and R⁷ are independently H, methyl, ethyl;
R⁶ and R⁷ are even more preferred both H;

A further embodiment of the present invention relates to compounds of formula (I)

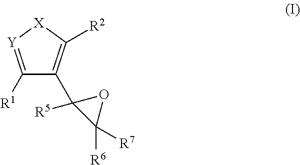

wherein
X is S or O;
Y is C—H or N;
R¹ is unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₁₋₈arylalkyl; substituted C₁₋₈arylalkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; or a substituted 5 to 10-membered aromatic heterocycle;
R² is H; halogen, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₁₋₈haloalkyl; substituted C₁₋₈haloalkyl; unsubstituted C₃₋₈cycloalkyl; substituted C₃₋₈cycloalkyl; unsubstituted C₇₋₁₅arylalkyl; substituted C₇₋₁₅arylalkyl; unsubstituted C₆₋₁₀aryloxy-C₁₋₈alkyl; substituted C₆₋₁₀aryloxy-C₁₋₈alkyl; unsubstituted C₆₋₁₀arylthio-C₁₋₈alkyl; substituted C₆₋₁₀arylthio-C₁₋₈alkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; a substituted 5 to 10-membered aromatic heterocycle; unsubstituted C₁₋₈alkylsilyl; or substituted C₁₋₈alkylsilyl;
R⁵ is a unsubstituted 5 to 10 membered aromatic heterocycle; or a substituted 5 to 10 membered aromatic heterocycle;
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; a unsubstituted 5 to 10 membered aromatic heterocycle; or a substituted 5 to 10 membered aromatic heterocycle;
   wherein the substituents of the substituted alkyl groups, the substituted alkenyl groups, the substituted alkynyl groups, the substituted alkoxy groups, substituted aryl groups and/or the aromatic heterocycle groups in the compound of formula (I) are selected from the following substituents F, Cl, Br, I, —OH, —CN, nitro, —C₁₋₄alkoxy, —C₁₋₄ alkylthio, Cl₁₋₄alkyl, C₂₋₄alkenyl, C₂₋₄alkenyl, C₂₋₄alkynyl, —C(O)H, —C(O)(C₁₋₄ alkyl), —C(O)(C₁₋₄ alkoxy), —C(O)NH₂, —C(O)NH(C₁₋₄ alkyl), —C(O)N(C₁₋₄ alkyl)(C₁₋₄ alkyl), —OC(O)NH(C₁₋₄alkyl), —OC(O)N(C₁₋₄alkyl)(C₁₋₄alkyl), —NHC(O)(C₁₋₄alkyl), —NHC(O)(C₁₋₄ alkoxy), —N(C₁₋₄ alkyl)C(O)(C₁₋₄alkyl), —N(C₁₋₄ alkyl)C(O)(C₁₋₄alkoxy), —OC(O) (C₁₋₄ alkyl), —OC(O)(C₁₋₄ alkoxy), —Si(C₁₋₄alkyl)₃, —Si(C₁₋₄alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₂₋₆alkynyl, —C₂₋₆alkenyl, heteroarylC₂₋₆alkynyl, —C₂₋₆alkenyl, C₃₋₈cycloalkyl; —NR⁸R⁹ where R⁸ and R⁹ are independently H, —C₁₋₄alkyl-C₂₋₄alkenyl, —C₂₋₄alkynyl or combine with the interjacent nitrogen to form a five- or six-membered ring which may comprise one or two or three heteroatoms (one or two N, O or S atoms in addition to the interjacent nitrogen atom), in which case the heterocyclic ring is unsubstituted or the heterocyclic ring is substituted by one or two C₁₋₄ alkyl groups, —C₂₋₄alkenyl or substituted —C₂₋₄alkenyl, —C₂₋₄alkynyl or substituted —C₂₋₄alkynyl, —C(O)H, —C(O)(C₁₋₄ alkyl), —C(O)(C₁₋₄ alkoxy), —C(O)NH₂, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄ alkyl)₃, —Si(C₁₋₄ alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₁₋₄alkynyl, —C₁₋₆alkynyl, wherein all the alkyl, alkenyl, alkynyl, alkoxy, aryl, aryloxy, arylthio or heteroaryl groups are either substituted or unsubstituted, preferably these substituents of the substituted groups bear only one further substituent, more preferably these substituents of the substituted groups are not further substituted.

Preferred compounds of formula (I) are those wherein
X is S or O;
Y is C—H or N;
R¹ is unsubstituted C₁₋₈alkyl; substituted C₁₋₈alkyl; unsubstituted C₁₋₈alkenyl; substituted C₁₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; or a substituted 5 to 10-membered aromatic heterocycle;
R² is H; halogen, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₁₋₈haloalkyl; substituted C₁₋₈haloalkyl; unsubstituted C₃₋₈cycloalkyl; substituted C₃₋₈cycloalkyl; unsubstituted C₇₋₁₅arylalkyl; substituted C₇₋₁₅arylalkyl; unsubstituted C₆₋₁₀aryloxy-C₁₋₈alkyl; substituted C₆₋₁₀aryloxy-C₁₋₈alkyl; unsubstituted C₆₋₁₀arylthio-C₁₋₈alkyl; substituted C₆₋₁₀arylthio-C₁₋₈alkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; a substituted 5 to 10-membered aromatic heterocycle; unsubstituted C₁₋₈alkylsilyl; or substituted C₁₋₈alkylsilyl;
R⁵ is a unsubstituted 5 to 6 membered aromatic heterocycle; or a substituted 5 to 6 membered aromatic heterocycle;
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl;

More preferred compounds of formula (I) are those wherein
X is S or O;
Y is C—H or N;
R¹ is unsubstituted C₃₋₈cycloalkyl; substituted C₃₋₈cycloalkyl; unsubstituted C₆₋₁₀aryl; substituted C₆₋₁₀aryl; unsubstituted C₆₋₁₀aryloxy; substituted C₆₋₁₀aryloxy; a unsubstituted 5 to 10-membered aromatic heterocycle; a substituted 5 to 10-membered aromatic heterocycle;
R² is unsubstituted C₁₋₈alkyl; substituted C₁₋₈alkyl; unsubstituted C₃₋₈cycloalkyl; substituted C₃₋₈cycloalkyl; unsubstituted C₆₋₁₀aryl; substituted C₆₋₁₀aryl; a unsubstituted 5 to 10-membered aromatic heterocycle; a substituted 5 to 10-membered aromatic heterocycle;
R⁵ is a unsubstituted 6 membered aromatic heterocycle comprising one or two nitrogen atoms; or a substituted 6 membered aromatic heterocycle comprising one or two nitrogen atoms;
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; preferably R⁶ and R⁷ are independently H, unsubstituted C₁₋₈alkyl; substituted C₁₋₈alkyl;

Even more preferred compounds of formula (I) are those wherein
X is S or O;
Y is C—H or N;
R¹ is unsubstituted C₆₋₁₀aryl; substituted C₆₋₁₀aryl;
R² is unsubstituted C₃₋₈cycloalkyl; substituted C₃₋₈cycloalkyl; unsubstituted C₆₋₁₀aryl; substituted C₆₋₁₀aryl;
R⁵ is a unsubstituted pyridyl or pyrimidyl; or a substituted pyridyl or pyrimidyl; preferably a unsubstituted pyridyl or pyrimidyl
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; preferably R⁶ and R⁷ are independently H, methyl, ethyl;

Most preferred compounds of formula (I) are those wherein
X is S or O;
Y is C—H or N;
R¹ is unsubstituted phenyl; phenyl substituted by Cl, F;
R² is unsubstituted cyclohexyl; unsubstituted phenyl; phenyl substituted by Cl, F;
R⁵ is unsubstituted pyridyl or pyrimidyl preferably a unsubstituted 3-pyridyl or 5-pyrimidyl;
R⁶ and R⁷ are both H;

In a further aspect of the present invention the preferred compounds (I) of the present invention have the formula (Ia)

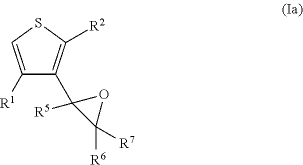

and the meaning of the substituents R¹, R², R⁵, R⁶ and R⁷ is as given above for the formula (I).

In a further aspect of the present invention the preferred compounds (I) of the present invention have the formula (Ib)

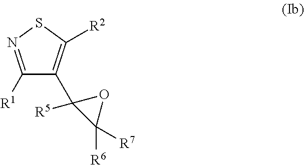

and the meaning of the substituents R¹, R², R⁵, R⁶ and R⁷ is as given above for the formula (I).

In a further aspect of the present invention the preferred compounds (I) of the present invention have the formula (Ic)

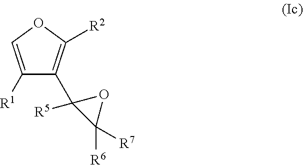

and the meaning of the substituents R¹, R², R⁵, R⁶ and R⁷ is as given above for the formula (I).

In a further aspect of the present invention the preferred compounds (I) of the present invention have the formula (Id)

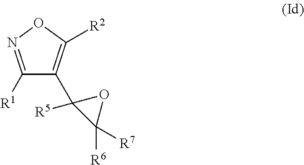

and the meaning of the substituents R¹, R², R⁵, R⁶ and R⁷ is as given above for the formula (I).

The compounds of formula (I) may exist in different geometric or optical isomeric forms or in different tautomeric forms. One or more centres of chirality may be present, in which case compounds of the formula (I) may be present as pure enantiomers, mixtures of enantiomers, pure diastereomers or mixtures of diastereomers. There may be double bonds present in the molecule, such as C═C or C═N bonds, in which case compounds of formula (I) may exist as single isomers or mixtures of isomers. Centres of tautomerisation may be present. This invention covers all such isomers and tautomers and mixtures thereof in all proportions as well as isotopic forms such as deuterated compounds. Also atropisomerism may occur as a result of a restricted rotation about a single bond.

Compounds of formula (I) may be prepared as shown in the following schemes.

Compounds of formula (I) may be prepared by the addition of a alkyl sulfonium or sulfoxonium salt, such as trimethylsulfonium iodide, trimethylsulfoxonium iodide or triisopropylsulfoxonium tetrafluoroborate, onto compounds of formula (A) in the presence of a base such as sodium hydride in a suitable solvent such as dimethyl sulfoxide at a temperature between 0° C. and 50° C. For example of analogous method see Corey E. J. and Chaykovsky M. J. Am. Chem. Soc. 1965, 87, 1353; Adams J. et al. J. Org. Chem. 1970, 35, 1600; Corey E. J. et al. Tetrahedron Lett. 1967, 2325; Aggarwal V. K. and Richardson, J. Chem. Commun. 2003, 2644.

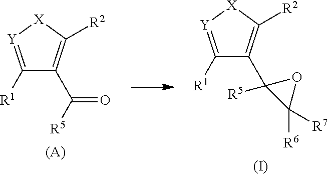

Compounds of formula (A) may be prepared by treating compounds of formula (B) with compounds of formula (C) under basic conditions. Suitable bases include lithium diisopropyl amide, butyl lithium, sodium hexamethyldisilazide and the reaction is preferably conducted in a suitable solvent such as tetrahydrofuran at a temperature between −80° C. and 30° C. For example, analogous methods to obtain compounds of formula (A) are described by Alberola, A. et al. Syn. Comm. 1987, 17(10), 1207-15; Buettelmann, B. WO2009000662.

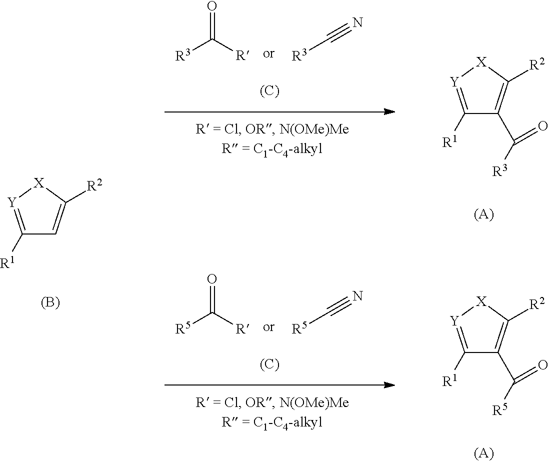

Compounds of formula (A) are known, or may be made from known compounds by known methods. For examples, see Hu, D.-J. et al. Molecules 2009, 14(3), 1288-1303; Diaz-Valenzuela, M. et al. Chemistry A European Journal 2009, 15(5), 1227-1232; Grecian, S, and Fokin, V. V. Angew. Chem. Int. Ed. 2008, 47(43), 8285-8287; Lee, S.-F. et al. WO2007075487; Lee, S.-F. et al. WO2006031631.

Compounds of formula (B) are known, or may be made from known compounds by known methods.

Compounds of formula (C) are known, or may be made from known compounds by known methods.

Additionally, compounds of formula (A) where Y is N and X is S may be prepared by the addition of nitrile sulfides of formula (D) onto compounds of formula (E) optionally in the presence of a catalyst, for example, aluminum chloride (III), optionally in a suitable solvent such as chlorobenzene at a temperature between 20° C. and 160° C.

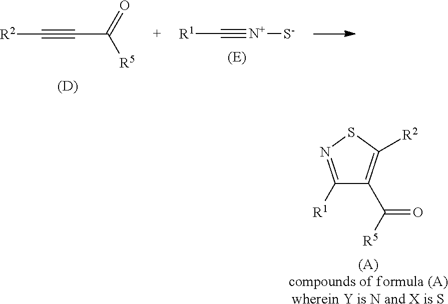

Compounds of formula (D) are known, or may be made from known compounds by known methods.

Compounds of formula (E) are known, or may be made from known compounds by known methods.

Additionally, compounds of formula (A) where Y is C—H and X is S may be prepared by the addition of acetylenethiolate of formula (F) onto compounds of formula (D) in a suitable solvent such as tetrahydrofuran or a mixture of solvent such as tetrahydrofunran and acetonitrile at a temperature between −80° C. and 30° C. For example, see Rodinova, L. S. et al. Zhurnal Organicheskoi Khimii 1981, 17(10), 2071-2075 and Lee, S.-F. et al. WO2007/075487.

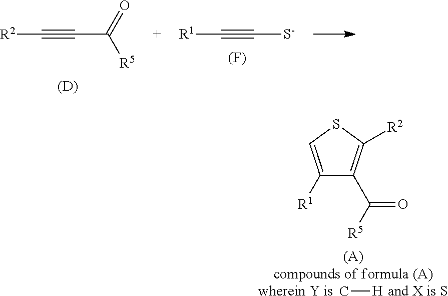

The acetylenethiolate of formula (F) may be prepared by the treatment of terminal acetylene (G) with a strong base such as n-butyllithium in an inert solvent such as tetrahydrofuran at a temperature between −80° C. and 30° C. followed be the addition of elemental sulfur to the reaction mixture at a temperature between −80° C. and 30° C. For example, see Raubenheimer H. G. et al. Organometallics 1988, 7, 1853-1858 and Lee, S.-F. et al. WO2007/075487.

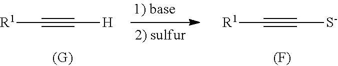

Compounds of formula (G) are known, or may be made from known compounds by known methods.

Compounds of formula (A) where Y is C—H and X is S may also be prepared by the addition of compounds of formula (H) to compounds of formula (D) followed by the dehydration of the intermediates of formula (J). The reaction is carried in the presence of a base, preferable an organic base such as morpholine, triethyl amine or Hunig's base in a suitable solvent such as dimethoxyethane at a temperature between 20° C. and 180° C. The intermediates of formula (J) are efficiently dehydrated by treatment with an organic acid such asp-toluenesulfoinc acid in a suitable solvent such as toluene at a temperature between 80° C. and 150° C.

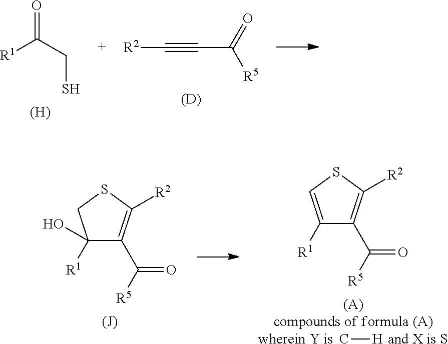

Compounds of formula (I) may also be prepared by treating compounds of formula (B) with compounds of formula (K) wherein Hal is an halogen, preferably chloride or bromide, under basic conditions. Suitable bases include lithium diisopropyl amide, butyl lithium, sodium hexamethyldisilazide and the reaction is preferably conducted in a suitable solvent such as tetrahydrofuran at a temperature between −80° C. and 30° C. For example, analogous methods are described by Ribereau P. and Queguiner, G. Can. J. Chem. 1983, 61, 334 and Trofimov, A. J. Am. Chem. Soc. 2008, 130, 13538.

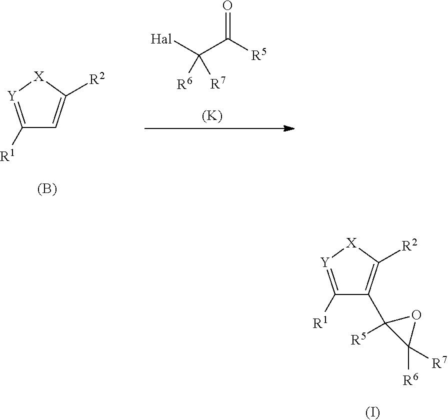

Compounds of formula (K) are known, or may be made from known compounds by known methods.

In a similar way, compounds of formula (I) may be prepared by treating compounds of formula (L) wherein Hal is a halogen, preferable bromide or iodide, with compounds of formula (K) under basic conditions. Suitable bases include butyl lithium, tert-butyl lithium, isopropyl magnesium bromide and the reaction is preferably conducted in a suitable solvent such as tetrahydrofuran at a temperature between −80° C. and 30° C.

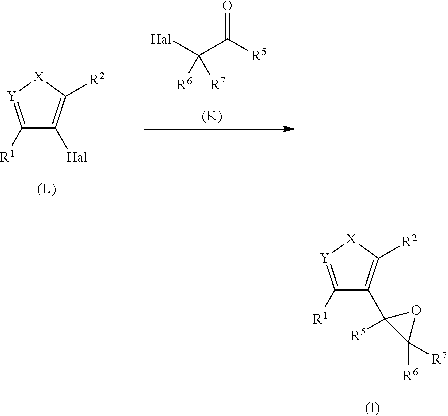

Compounds of formula (L) may be prepared by treating compounds of formula (B) with a halogenating agent, for example N-bromosuccinimide, in a suitable solvent such as acetonitrile or acetic acid at a temperature between 0° C. and 150° C. For example, analogous methods are described by Day, R. A. et al. Synthesis 2003, 10, 1586-1590.

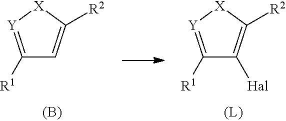

The reactions to give compounds of formula (I) are advantageously carried out in aprotic inert organic solvents. Such solvents are hydrocarbons such as benzene, toluene, xylene or cyclohexane, chlorinated hydrocarbons such as dichloromethane, trichloromethane, tetrachloromethane or chlorobenzene, ethers such as diethyl ether, ethylene glycol dimethyl ether, diethylene glycol dimethyl ether, tetrahydrofuran or dioxane, nitriles such as acetonitrile or propionitrile, amides such as N,N-dimethylformamide, diethylformamide or N-methylpyrrolidinone. The reaction temperatures are advantageously between −20° C. and +120° C. In general, the reactions are slightly exothermic and, as a rule, they can be carried out at ambient temperature. To shorten the reaction time, or else to start the reaction, the mixture may be heated briefly to the boiling point of the reaction mixture. The reaction times can also be shortened by adding a few drops of base as reaction catalyst. Suitable bases are, in particular, tertiary amines such as trimethylamine, triethylamine, quinuclidine, 1,4-diazabicyclo[2.2.2]octane, 1,5-diazabicyclo[4.3.0]non-5-ene or 1,5-diazabicyclo-[5.4.0]undec-7-ene. However, inorganic bases such as hydrides, e.g. sodium hydride or calcium hydride, hydroxides, e.g. sodium hydroxide or potassium hydroxide, carbonates such as sodium carbonate and potassium carbonate, or hydrogen carbonates such as potassium hydrogen carbonate and sodium hydrogen carbonate may also be used as bases. The bases can be used as such or else with catalytic amounts of a phase-transfer catalyst, for example a crown ether, in particular 18-crown-6, or a tetraalkylammonium salt.

The compounds of formula (I) and, where appropriate, the tautomers thereof, can, if appropriate, also be obtained in the form of hydrates and/or include other solvents, for example those which may have been used for the crystallization of compounds which are present in solid form.

It has now been found that the compounds of formula (I) according to the invention have, for practical purposes, a very advantageous spectrum of activities for protecting useful plants against diseases that are caused by phytopathogenic microorganisms, such as fungi, bacteria or viruses.

The invention therefore also relates to a method of controlling or preventing infestation of useful plants by phytopathogenic microorganisms, wherein a compound of formula (I) is applied as active ingredient to the plants, to parts thereof or the locus thereof. The compounds of formula (I) according to the invention are distinguished by excellent activity at low rates of application, by being well tolerated by plants and by being environmentally safe. They have very useful curative, preventive and systemic properties and are used for protecting numerous useful plants. The compounds of formula (I) can be used to inhibit or destroy the diseases that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula (I) as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore, the compounds of formula (I) according to the invention may be used for controlling fungi in related areas, for example in the protection of technical materials, including wood and wood related technical products, in food storage or in hygiene management.

The compounds of formula (I) are, for example, effective against the phytopathogenic fungi of the following classes: Fungi imperfecti (e.g. Botrytis, Pyricularia, Helminthosporium, Fusarium, Septoria, Cercospora and Alternaria) and Basidiomycetes (e.g. Rhizoctonia, Hemileia, Puccinia). Additionally, they are also effective against the Ascomycetes classes (e.g. Venturia and Erysiphe, Podosphaera, Monilinia, Uncinula) and of the Oomycetes classes (e.g. Phytophthora, Pythium, Plasmopara). Furthermore, the novel compounds of formula (I) are effective against phytopathogenic bacteria and viruses (e.g. against Xanthomonas spp, Pseudomonas spp, Erwinia amylovora as well as against the tobacco mosaic virus). The compounds of formula (I) are also effective against Asian soybean rust (Phakopsora pachyrhizi).

Within the scope of the invention, useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); Nature-Gard® Agrisure® GT Advantage (GA21 glyphosate-tolerant trait), Agrisure® CB Advantage (Bt11 corn borer (CB) trait), Agrisure® RW (corn rootworm trait) and Protecta®.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula (I) can be used in unmodified form or, preferably, together with carriers and adjuvants conventionally employed in the art of formulation.

Therefore the invention also relates to compositions for controlling and protecting against phytopathogenic microorganisms, comprising a compound of formula (I) and an inert carrier, and to a method of controlling or preventing infestation of useful plants by phytopathogenic microorganisms, wherein a composition, comprising a compound of formula (I) as active ingredient and an inert carrier, is applied to the plants, to parts thereof or the locus thereof.

To this end compounds of formula (I) and inert carriers are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants (auxiliaries) can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The compounds of formula (I) or compositions, comprising a compound of formula (I) as active ingredient and an inert carrier, can be applied to the locus of the plant or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

A preferred method of applying a compound of formula (I), or a composition, comprising a compound of formula (I) as active ingredient and an inert carrier, is foliar application. The frequency of application and the rate of application will depend on the risk of infestation by the corresponding pathogen. However, the compounds of formula (I) can also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula (I) may also be applied to seeds (coating) by impregna-ting the seeds or tubers either with a liquid formulation of the fungicide or coating them with a solid formulation.

A formulation, i.e. a composition comprising the compound of formula (I) and, if desired, a solid or liquid adjuvant, is prepared in a known manner, typically by intimately mixing and/or grinding the compound with extenders, for example solvents, solid carriers and, optionally, surface-active compounds (surfactants).

The agrochemical formulations will usually contain from 0.1 to 99% by weight, preferably from 0.1 to 95% by weight, of the compound of formula (I), 99.9 to 1% by weight, preferably 99.8 to 5% by weight, of a solid or liquid adjuvant, and from 0 to 25% by weight, preferably from 0.1 to 25% by weight, of a surfactant.

Whereas it is preferred to formulate commercial products as concentrates, the end user will normally use dilute formulations.

Advantageous rates of application are normally from 5 g to 2 kg of active ingredient (a.i.) per hectare (ha), preferably from 10 g to 1 kg a.i./ha, most preferably from 20 g to 600 g a.i./ha. When used as seed drenching agent, convenient rates of application are from 10 mg to 1 g of active substance per kg of seeds. The rate of application for the desired action can be determined by experiments. It depends for example on the type of action, the developmental stage of the useful plant, and on the application (location, timing, application method) and can, owing to these parameters, vary within wide limits.

The compounds of formula (I), or a pharmaceutical salt thereof, described above may also have an advantageous spectrum of activity for the treatment and/or prevention of microbial infection in an animal. “Animal” can be any animal, for example, insect, mammal, reptile, fish, amphibian, preferably mammal, most preferably human. “Treatment” means the use on an animal which has microbial infection in order to reduce or slow or stop the increase or spread of the infection, or to reduce the infection or to cure the infection. “Prevention” means the use on an animal which has no apparent signs of microbial infection in order to prevent any future infection, or to reduce or slow the increase or spread of any future infection. According to the present invention there is provided the use of a compound of formula (I) in the manufacture of a medicament for use in the treatment and/or prevention of microbial infection in an animal. There is also provided the use of a compound of formula (I) as a pharmaceutical agent. There is also provided the use of a compound of formula (I) as an antimicrobial agent in the treatment of an animal. According to the present invention there is also provided a pharmaceutical composition comprising as an active ingredient a compound of formula (I), or a pharmaceutically acceptable salt thereof, and a pharmaceutically acceptable diluent or carrier. This composition can be used for the treatment and/or prevention of antimicrobial infection in an animal. This pharmaceutical composition can be in a form suitable for oral administration, such as tablet, lozenges, hard capsules, aqueous suspensions, oily suspensions, emulsions dispersible powders, dispersible granules, syrups and elixirs. Alternatively this pharmaceutical composition can be in a form suitable for topical application, such as a spray, a cream or lotion. Alternatively this pharmaceutical composition can be in a form suitable for parenteral administration, for example injection. Alternatively this pharmaceutical composition can be in inhalable form, such as an aerosol spray.

The compounds of formula (I) may be effective against various microbial species able to cause a microbial infection in an animal. Examples of such microbial species are those causing brown rust such as Puccinia recondita, those that are causing leaf blotch such as Septoria tritici, those that are causing gray mould such as Botrytis cinerea, those causing Aspergillosis such as Aspergillus fumigatus, A. flavus, A. terrus, A. nidulans and A. niger; those causing Blastomycosis such as Blastomyces dermatitidis; those causing Candidiasis such as Candida albicans, C. glabrata, C. tropicalis, C. parapsilosis, C. krusei and C. lusitaniae; those causing Coccidioidomycosis such as Coccidioides immitis; those causing Cryptococcosis such as Cryptococcus neoformans; those causing Histoplasmosis such as Histoplasma capsulatum and those causing Zygomycosis such as Absidia corymbifera, Rhizomucor pusillus and Rhizopus arrhizus. Further examples are Fusarium Spp such as Fusarium oxysporum and Fusarium solani and Scedosporium Spp such as Scedosporium apiospermum and Scedosporium prolificans. Still further examples are Microsporum Spp, Trichophyton Spp, Epidermophyton Spp, Mucor Spp, Sporothorix Spp, Phialophora Spp, Cladosporium Spp, Petriellidium spp, Paracoccidioides Spp and Histoplasma Spp.

It has been found that the use of a further, other compound or compositions (e.g. a further, other biocidally active ingredients or compositions) in combination with the compound of formula (I) surprisingly and substantially enhance the effectiveness of the latter against fungi, and vice versa. Additionally, the method of the invention is effective against a wider spectrum of such fungi that can be combated with the active ingredients of this method, when used solely.

The activity of the compositions according to the invention can be broadened considerably, and adapted to prevailing circumstances, by adding other insecticidally, acaricidally and/or fungicidally active ingredients. The mixtures of the compounds of formula I with other insecticidally, acaricidally and/or fungicidally active ingredients may also have further surprising advantages which can also be described, in a wider sense, as synergistic activity. For example, better tolerance by plants, reduced phytotoxicity, insects can be controlled in their different development stages or better behaviour during their production, for example during grinding or mixing, during their storage or during their use.

Suitable additions to active ingredients here are, for example, representatives of the following classes of active ingredients: organophosphorus compounds, nitrophenol derivatives, thioureas, juvenile hormones, formamidines, benzophenone derivatives, ureas, pyrrole derivatives, carbamates, pyrethroids, chlorinated hydrocarbons, acylureas, pyridyl-methyleneamino derivatives, macrolides, neonicotinoids and Bacillus thuringiensis preparations.

The following mixtures of the compounds of formula I with active ingredients are preferred (the abbreviation “TX” means “one compound selected from a compound of formula (I) or a compound of the group consisting of the compounds of formulae T1.1 to T1.28 and T2.1 and T3.1 to T28.217 described in 1 to 28 of the present invention”):

an adjuvant selected from the group of substances consisting of petroleum oils (alternative name) (628)+TX,
an acaricide selected from the group of substances consisting of 1,1-bis(4-chlorophenyl)-2-ethoxyethanol (IUPAC name) (910)+TX, 2,4-dichlorophenyl benzenesulfonate (IUPAC/Chemical Abstracts name) (1059)+TX, 2-fluoro-N-methyl-N-1-naphthylacetamide (IUPAC name) (1295)+TX, 4-chlorophenyl phenyl sulfone (IUPAC name) (981)+TX, abamectin (1)+TX, acequinocyl (3)+TX, acetoprole [CCN]+TX, acrinathrin (9)+TX, aldicarb (16)+TX, aldoxycarb (863)+TX, alpha-cypermethrin (202)+TX, amidithion (870)+TX, amidoflumet [CCN]+TX, amidothioate (872)+TX, amiton (875)+TX, amiton hydrogen oxalate (875)+TX, amitraz (24)+TX, aramite (881)+TX, arsenous oxide (882)+TX, AVI 382 (compound code)+TX, AZ 60541 (compound code)+TX, azinphos-ethyl (44)+TX, azinphos-methyl (45)+TX, azobenzene (IUPAC name) (888)+TX, azocyclotin (46)+TX, azothoate (889)+TX, benomyl (62)+TX, benoxafos (alternative name) [CCN]+TX, benzoximate (71)+TX, benzyl benzoate (IUPAC name) [CCN]+TX, bifenazate (74)+TX, bifenthrin (76)+TX, binapacryl (907)+TX, brofenvalerate (alternative name)+TX, bromocyclen (918)+TX, bromophos (920)+TX, bromophos-ethyl (921)+TX, bromopropylate (94)+TX, buprofezin (99)+TX, butocarboxim (103)+TX, butoxycarboxim (104)+TX, butylpyridaben (alternative name)+TX, calcium polysulfide (IUPAC name) (111)+TX, camphechlor (941)+TX, carbanolate (943)+TX, carbaryl (115)+TX, carbofuran (118)+TX, carbophenothion (947)+TX, CGA 50′439 (development code) (125)+TX, chinomethionat (126)+TX, chlorbenside (959)+TX, chlordimeform (964)+TX, chlordimeform hydrochloride (964)+TX, chlorfenapyr (130)+TX, chlorfenethol (968)+TX, chlorfenson (970)+TX, chlorfensulphide (971)+TX, chlorfenvinphos (131)+TX, chlorobenzilate (975)+TX, chloromebuform (977)+TX, chloromethiuron (978)+TX, chloropropylate (983)+TX, chlorpyrifos (145)+TX, chlorpyrifos-methyl (146)+TX, chlorthiophos (994)+TX, cinerin I (696)+TX, cinerin II (696)+TX, cinerins (696)+TX, clofentezine (158)+TX, closantel (alternative name) [CCN]+TX, coumaphos (174)+TX, crotamiton (alternative name) [CCN]+TX, crotoxyphos (1010)+TX, cufraneb (1013)+TX, cyanthoate (1020)+TX, cyflumetofen (CAS Reg. No.: 400882-07-7)+TX, cyhalothrin (196)+TX, cyhexatin (199)+TX, cypermethrin (201)+TX, DCPM (1032)+TX, DDT (219)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-5-methyl (224)+TX, demeton-S-methylsulphon (1039)+TX, diafenthiuron (226)+TX, dialifos (1042)+TX, diazinon (227)+TX, dichlofluanid (230)+TX, dichlorvos (236)+TX, dicliphos (alternative name)+TX, dicofol (242)+TX, dicrotophos (243)+TX, dienochlor (1071)+TX, dimefox (1081)+TX, dimethoate (262)+TX, dinactin (alternative name) (653)+TX, dinex (1089)+TX, dinex-diclexine (1089)+TX, dinobuton (269)+TX, dinocap (270)+TX, dinocap-4 [CCN]+TX, dinocap-6 [CCN]+TX, dinocton (1090)+TX, dinopenton (1092)+TX, dinosulfon (1097)+TX, dinoterbon (1098)+TX, dioxathion (1102)+TX, diphenyl sulfone (IUPAC name) (1103)+TX, disulfuram (alternative name) [CCN]+TX, disulfoton (278)+TX, DNOC (282)+TX, dofenapyn (1113)+TX, doramectin (alternative name) [CCN]+TX, endosulfan (294)+TX, endothion (1121)+TX, EPN (297)+TX, eprinomectin (alternative name) [CCN]+TX, ethion (309)+TX, ethoate-methyl (1134)+TX, etoxazole (320)+TX, etrimfos (1142)+TX, fenazaflor (1147)+TX, fenazaquin (328)+TX, fenbutatin oxide (330)+TX, fenothiocarb (337)+TX, fenpropathrin (342)+TX, fenpyrad (alternative name)+TX, fenpyroximate (345)+TX, fenson (1157)+TX, fentrifanil (1161)+TX, fenvalerate (349)+TX, fipronil (354)+TX, fluacrypyrim (360)+TX, fluazuron (1166)+TX, flubenzimine (1167)+TX, flucycloxuron (366)+TX, flucythrinate (367)+TX, fluenetil (1169)+TX, flufenoxuron (370)+TX, flumethrin (372)+TX, fluorbenside (1174)+TX, fluvalinate (1184)+TX, FMC 1137 (development code) (1185)+TX, formetanate (405)+TX, formetanate hydrochloride (405)+TX, formothion (1192)+TX, formparanate (1193)+TX, gamma-HCH (430)+TX, glyodin (1205)+TX, halfenprox (424)+TX, heptenophos (432)+TX, hexadecyl cyclopropanecarboxylate (IUPAC/Chemical Abstracts name) (1216)+TX, hexythiazox (441)+TX, iodomethane (IUPAC name) (542)+TX, isocarbophos (alternative name) (473)+TX, isopropyl O-(methoxyaminothiophosphoryl)salicylate (IUPAC name) (473)+TX, ivermectin (alternative name) [CCN]+TX, jasmolin I (696)+TX, jasmolin II (696)+TX, jodfenphos (1248)+TX, lindane (430)+TX, lufenuron (490)+TX, malathion (492)+TX, malonoben (1254)+TX, mecarbam (502)+TX, mephosfolan (1261)+TX, mesulfen (alternative name) [CCN]+TX, methacrifos (1266)+TX, methamidophos (527)+TX, methidathion (529)+TX, methiocarb (530)+TX, methomyl (531)+TX, methyl bromide (537)+TX, metolcarb (550)+TX, mevinphos (556)+TX, mexacarbate (1290)+TX, milbemectin (557)+TX, milbemycin oxime (alternative name) [CCN]+TX, mipafox (1293)+TX, monocrotophos (561)+TX, morphothion (1300)+TX, moxidectin (alternative name) [CCN]+TX, naled (567)+TX, NC-184 (compound code)+TX, NC-512 (compound code)+TX, nifluridide (1309)+TX, nikkomycins (alternative name) [CCN]+TX, nitrilacarb (1313)+TX, nitrilacarb 1:1 zinc chloride complex (1313)+TX, NNI-0101 (compound code)+TX, NNI-0250 (compound code)+TX, omethoate (594)+TX, oxamyl (602)+TX, oxydeprofos (1324)+TX, oxydisulfoton (1325)+TX, pp′-DDT (219)+TX, parathion (615)+TX, permethrin (626)+TX, petroleum oils (alternative name) (628)+TX, phenkapton (1330)+TX, phenthoate (631)+TX, phorate (636)+TX, phosalone (637)+TX, phosfolan (1338)+TX, phosmet (638)+TX, phosphamidon (639)+TX, phoxim (642)+TX, pirimiphos-methyl (652)+TX, polychloroterpenes (traditional name) (1347)+TX, polynactins (alternative name) (653)+TX, proclonol (1350)+TX, profenofos (662)+TX, promacyl (1354)+TX, propargite (671)+TX, propetamphos (673)+TX, propoxur (678)+TX, prothidathion (1360)+TX, prothoate (1362)+TX, pyrethrin I (696)+TX, pyrethrin II (696)+TX, pyrethrins (696)+TX, pyridaben (699)+TX, pyridaphenthion (701)+TX, pyrimidifen (706)+TX, pyrimitate (1370)+TX, quinalphos (711)+TX, quintiofos (1381)+TX, R-1492 (development code) (1382)+TX, RA-17 (development code) (1383)+TX, rotenone (722)+TX, schradan (1389)+TX, sebufos (alternative name)+TX, selamectin (alternative name) [CCN]+TX, SI-0009 (compound code)+TX, sophamide (1402)+TX, spirodiclofen (738)+TX, spiromesifen (739)+TX, SSI-121 (development code) (1404)+TX, sulfuram (alternative name) [CCN]+TX, sulfluramid (750)+TX, sulfotep (753)+TX, sulphur (754)+TX, SZI-121 (development code) (757)+TX, tau-fluvalinate (398)+TX, tebufenpyrad (763)+TX, TEPP (1417)+TX, terbam (alternative name)+TX, tetrachlorvinphos (777)+TX, tetradifon (786)+TX, tetranactin (alternative name) (653)+TX, tetrasul (1425)+TX, thiafenox (alternative name)+TX, thiocarboxime (1431)+TX, thiofanox (800)+TX, thiometon (801)+TX, thioquinox (1436)+TX, thuringiensin (alternative name) [CCN]+TX, triamiphos (1441)+TX, triarathene (1443)+TX, triazophos (820)+TX, triazuron (alternative name)+TX, trichlorfon (824)+TX, trifenofos (1455)+TX, trinactin (alternative name) (653)+TX, vamidothion (847)+TX, vaniliprole [CCN] and yl-5302 (compound code)+TX, an algicide selected from the group of substances consisting of bethoxazin [CCN]+TX, copper dioctanoate (IUPAC name) (170)+TX, copper sulfate (172)+TX, cybutryne [CCN]+TX, dichlone (1052)+TX, dichlorophen (232)+TX, endothal (295)+TX, fentin (347)+TX, hydrated lime [CCN]+TX, nabam (566)+TX, quinoclamine (714)+TX, quinonamid (1379)+TX, simazine (730)+TX, triphenyltin acetate (IUPAC name) (347) and triphenyltin hydroxide (IUPAC name) (347)+TX,
an anthelmintic selected from the group of substances consisting of abamectin (1)+TX, crufomate (1011)+TX, doramectin (alternative name) [CCN]+TX, emamectin (291)+TX, emamectin benzoate (291)+TX, eprinomectin (alternative name) [CCN]+TX, ivermectin (alternative name) [CCN]+TX, milbemycin oxime (alternative name) [CCN]+TX, moxidectin (alternative name) [CCN]+TX, piperazine [CCN]+TX, selamectin (alternative name) [CCN]+TX, spinosad (737) and thiophanate (1435)+TX, an avicide selected from the group of substances consisting of chloralose (127)+TX, endrin (1122)+TX, fenthion (346)+TX, pyridin-4-amine (IUPAC name) (23) and strychnine (745)+TX,
a bactericide selected from the group of substances consisting of 1-hydroxy-1H-pyridine-2-thione (IUPAC name) (1222)+TX, 4-(quinoxalin-2-ylamino)benzenesulfonamide (IUPAC name) (748)+TX, 8-hydroxyquinoline sulfate (446)+TX, bronopol (97)+TX, copper dioctanoate (IUPAC name) (170)+TX, copper hydroxide (IUPAC name) (169)+TX, cresol [CCN]+TX, dichlorophen (232)+TX, dipyrithione (1105)+TX, dodicin (1112)+TX, fenaminosulf (1144)+TX, formaldehyde (404)+TX, hydrargaphen (alternative name) [CCN]+TX, kasugamycin (483)+TX, kasugamycin hydrochloride hydrate (483)+TX, nickel bis(dimethyldithiocarbamate) (IUPAC name) (1308)+TX, nitrapyrin (580)+TX, octhilinone (590)+TX, oxolinic acid (606)+TX, oxytetracycline (611)+TX, potassium hydroxyquinoline sulfate (446)+TX, probenazole (658)+TX, streptomycin (744)+TX, streptomycin sesquisulfate (744)+TX, tecloftalam (766)+TX, and thiomersal (alternative name) [CCN]+TX,
a biological agent selected from the group of substances consisting of Adoxophyes orana GV (alternative name) (12)+TX, Agrobacterium radiobacter (alternative name) (13)+TX, Amblyseius spp. (alternative name) (19)+TX, Anagrapha falcifera NPV (alternative name) (28)+TX, Anagrus atomus (alternative name) (29)+TX, Aphelinus abdominalis (alternative name) (33)+TX, Aphidius colemani (alternative name) (34)+TX, Aphidoletes aphidimyza (alternative name) (35)+TX, Autographa californica NPV (alternative name) (38)+TX, Bacillus firmus (alternative name) (48)+TX, Bacillus sphaericus Neide (scientific name) (49)+TX, Bacillus thuringiensis Berliner (scientific name) (51)+TX, Bacillus thuringiensis subsp. aizawai (scientific name) (51)+TX, Bacillus thuringiensis subsp. israelensis (scientific name) (51)+TX, Bacillus thuringiensis subsp. japonensis (scientific name) (51)+TX, Bacillus thuringiensis subsp. kurstaki (scientific name) (51)+TX, Bacillus thuringiensis subsp. tenebrionis (scientific name) (51)+TX, Beauveria bassiana (alternative name) (53)+TX, Beauveria brongniartii (alternative name) (54)+TX, Chrysoperla carnea (alternative name) (151)+TX, Cryptolaemus montrouzieri (alternative name) (178)+TX, Cydia pomonella GV (alternative name) (191)+TX, Dacnusa sibirica (alternative name) (212)+TX, Diglyphus isaea (alternative name) (254)+TX, Encarsia formosa (scientific name) (293)+TX, Eretmocerus eremicus (alternative name) (300)+TX, Helicoverpa zea NPV (alternative name) (431)+TX, Heterorhabditis bacteriophora and H. megidis (alternative name) (433)+TX, Hippodamia convergens (alternative name) (442)+TX, Leptomastix dactylopii (alternative name) (488)+TX, Macrolophus caliginosus (alternative name) (491)+TX, Mamestra brassicae NPV (alternative name) (494)+TX, Metaphycus helvolus (alternative name) (522)+TX, Metarhizium anisopliae var. acridum (scientific name) (523)+TX, Metarhizium anisopliae var. anisopliae (scientific name) (523)+TX, Neodiprion sertifer NPV and N. lecontei NPV (alternative name) (575)+TX, Orius spp. (alternative name) (596)+TX, Paecilomyces fumosoroseus (alternative name) (613)+TX, Phytoseiulus persimilis (alternative name) (644)+TX, Spodoptera exigua multicapsid nuclear polyhedrosis virus (scientific name) (741)+TX, Steinernema bibionis (alternative name) (742)+TX, Steinernema carpocapsae (alternative name) (742)+TX, Steinernema feltiae (alternative name) (742)+TX, Steinernema glaseri (alternative name) (742)+TX, Steinernema riobrave (alternative name) (742)+TX, Steinernema riobravis (alternative name) (742)+TX, Steinernema scapterisci (alternative name) (742)+TX, Steinernema spp. (alternative name) (742)+TX, Trichogramma spp. (alternative name) (826)+TX, Typhlodromus occidentalis (alternative name) (844) and Verticillium lecanii (alternative name) (848)+TX,
a soil sterilant selected from the group of substances consisting of iodomethane (IUPAC name) (542) and methyl bromide (537)+TX,
a chemosterilant selected from the group of substances consisting of apholate [CCN]+TX, bisazir (alternative name) [CCN]+TX, busulfan (alternative name) [CCN]+TX, diflubenzuron (250)+TX, dimatif (alternative name) [CCN]+TX, hemel [CCN]+TX, hempa [CCN]+TX, metepa [CCN]+TX, methiotepa [CCN]+TX, methyl apholate [CCN]+TX, morzid [CCN]+TX, penfluoron (alternative name) [CCN]+TX, tepa [CCN]+TX, thiohempa (alternative name) [CCN]+TX, thiotepa (alternative name) [CCN]+TX, tretamine (alternative name) [CCN] and uredepa (alternative name) [CCN]+TX, an insect pheromone selected from the group of substances consisting of (E)-dec-5-en-1-yl acetate with (E)-dec-5-en-1-ol (IUPAC name) (222)+TX, (E)-tridec-4-en-1-yl acetate (IUPAC name) (829)+TX, (E)-6-methylhept-2-en-4-ol (IUPAC name) (541)+TX, (E,Z)-tetradeca-4,10-dien-1-yl acetate (IUPAC name) (779)+TX, (Z)-dodec-7-en-1-yl acetate (IUPAC name) (285)+TX, (Z)-hexadec-11-enal (IUPAC name) (436)+TX, (Z)-hexadec-11-en-1-yl acetate (IUPAC name) (437)+TX, (Z)-hexadec-13-en-11-yn-1-yl acetate (IUPAC name) (438)+TX, (Z)-icos-13-en-10-one (IUPAC name) (448)+TX, (Z)-tetradec-7-en-1-al (IUPAC name) (782)+TX, (Z)-tetradec-9-en-1-ol (IUPAC name) (783)+TX, (Z)-tetradec-9-en-1-yl acetate (IUPAC name) (784)+TX, (7E,9Z)-dodeca-7,9-dien-1-yl acetate (IUPAC name) (283)+TX, (9Z,11E)-tetradeca-9,11-dien-1-yl acetate (IUPAC name) (780)+TX, (9Z, 12E)-tetradeca-9,12-dien-1-yl acetate (IUPAC name) (781)+TX, 14-methyloctadec-1-ene (IUPAC name) (545)+TX, 4-methylnonan-5-ol with 4-methylnonan-5-one (IUPAC name) (544)+TX, alpha-multistriatin (alternative name) [CCN]+TX, brevicomin (alternative name) [CCN]+TX, codlelure (alternative name) [CCN]+TX, codlemone (alternative name) (167)+TX, cuelure (alternative name) (179)+TX, disparlure (277)+TX, dodec-8-en-1-yl acetate (IUPAC name) (286)+TX, dodec-9-en-1-yl acetate (IUPAC name) (287)+TX, dodeca-8+TX, 10-dien-1-yl acetate (IUPAC name) (284)+TX, dominicalure (alternative name) [CCN]+TX, ethyl 4-methyloctanoate (IUPAC name) (317)+TX, eugenol (alternative name) [CCN]+TX, frontalin (alternative name) [CCN]+TX, gossyplure (alternative name) (420)+TX, grandlure (421)+TX, grandlure I (alternative name) (421)+TX, grandlure II (alternative name) (421)+TX, grandlure III (alternative name) (421)+TX, grandlure IV (alternative name) (421)+TX, hexylure [CCN]+TX, ipsdienol (alternative name) [CCN]+TX, ipsenol (alternative name) [CCN]+TX, japonilure (alternative name) (481)+TX, lineatin (alternative name) [CCN]+TX, litlure (alternative name) [CCN]+TX, looplure (alternative name) [CCN]+TX, medlure [CCN]+TX, megatomoic acid (alternative name) [CCN]+TX, methyl eugenol (alternative name) (540)+TX, muscalure (563)+TX, octadeca-2,13-dien-1-yl acetate (IUPAC name) (588)+TX, octadeca-3,13-dien-1-yl acetate (IUPAC name) (589)+TX, orfralure (alternative name) [CCN]+TX, oryctalure (alternative name) (317)+TX, ostramone (alternative name) [CCN]+TX, siglure [CCN]+TX, sordidin (alternative name) (736)+TX, sulcatol (alternative name) [CCN]+TX, tetradec-11-en-1-yl acetate (IUPAC name) (785)+TX, trimedlure (839)+TX, trimedlure A (alternative name) (839)+TX, trimedlure B₁ (alternative name) (839)+TX, trimedlure B₂ (alternative name) (839)+TX, trimedlure C (alternative name) (839) and trunc-call (alternative name) [CCN]+TX, an insect repellent selected from the group of substances consisting of 2-(octylthio)ethanol (IUPAC name) (591)+TX, butopyronoxyl (933)+TX, butoxy(polypropylene glycol) (936)+TX, dibutyl adipate (IUPAC name) (1046)+TX, dibutyl phthalate (1047)+TX, dibutyl succinate (IUPAC name) (1048)+TX, diethyltoluamide [CCN]+TX, dimethyl carbate [CCN]+TX, dimethyl phthalate [CCN]+TX, ethyl hexanediol (1137)+TX, hexamide [CCN]+TX, methoquin-butyl (1276)+TX, methylneodecanamide [CCN]+TX, oxamate [CCN] and picaridin [CCN]+TX,
an insecticide selected from the group of substances consisting of 1-dichloro-1-nitroethane (IUPAC/Chemical Abstracts name) (1058)+TX, 1,1-dichloro-2,2-bis(4-ethylphenyl)ethane (IUPAC name) (1056), +TX, 1,2-dichloropropane (IUPAC/Chemical Abstracts name) (1062)+TX, 1,2-dichloropropane with 1,3-dichloropropene (IUPAC name) (1063)+TX, 1-bromo-2-chloroethane (IUPAC/Chemical Abstracts name) (916)+TX, 2,2,2-trichloro-1-(3,4-dichlorophenyl)ethyl acetate (IUPAC name) (1451)+TX, 2,2-dichlorovinyl 2-ethylsulphinylethyl methyl phosphate (IUPAC name) (1066)+TX, 2-(1,3-dithiolan-2-yl)phenyl dimethylcarbamate (IUPAC/Chemical Abstracts name) (1109)+TX, 2-(2-butoxyethoxy)ethyl thiocyanate (IUPAC/Chemical Abstracts name) (935)+TX, 2-(4,5-dimethyl-1,3-dioxolan-2-yl)phenyl methylcarbamate (IUPAC/Chemical Abstracts name) (1084)+TX, 2-(4-chloro-3,5-xylyloxy)ethanol (IUPAC name) (986)+TX, 2-chlorovinyl diethyl phosphate (IUPAC name) (984)+TX, 2-imidazolidone (IUPAC name) (1225)+TX, 2-isovalerylindan-1,3-dione (IUPAC name) (1246)+TX, 2-methyl(prop-2-ynyl)aminophenyl methylcarbamate (IUPAC name) (1284)+TX, 2-thiocyanatoethyl laurate (IUPAC name) (1433)+TX, 3-bromo-1-chloroprop-1-ene (IUPAC name) (917)+TX, 3-methyl-1-phenylpyrazol-5-yl dimethylcarbamate (IUPAC name) (1283)+TX, 4-methyl(prop-2-ynyl)amino-3,5-xylyl methylcarbamate (IUPAC name) (1285)+TX, 5,5-dimethyl-3-oxocyclohex-1-enyl dimethylcarbamate (IUPAC name) (1085)+TX, abamectin (1)+TX, acephate (2)+TX, acetamiprid (4)+TX, acethion (alternative name) [CCN]+TX, acetoprole [CCN]+TX, acrinathrin (9)+TX, acrylonitrile (IUPAC name) (861)+TX, alanycarb (15)+TX, aldicarb (16)+TX, aldoxycarb (863)+TX, aldrin (864)+TX, allethrin (17)+TX, allosamidin (alternative name) [CCN]+TX, allyxycarb (866)+TX, alpha-cypermethrin (202)+TX, alpha-ecdysone (alternative name) [CCN]+TX, aluminium phosphide (640)+TX, amidithion (870)+TX, amidothioate (872)+TX, aminocarb (873)+TX, amiton (875)+TX, amiton hydrogen oxalate (875)+TX, amitraz (24)+TX, anabasine (877)+TX, athidathion (883)+TX, AVI 382 (compound code)+TX, AZ 60541 (compound code)+TX, azadirachtin (alternative name) (41)+TX, azamethiphos (42)+TX, azinphos-ethyl (44)+TX, azinphos-methyl (45)+TX, azothoate (889)+TX, Bacillus thuringiensis delta endotoxins (alternative name) (52)+TX, barium hexafluorosilicate (alternative name) [CCN]+TX, barium polysulfide (IUPAC/Chemical Abstracts name) (892)+TX, barthrin [CCN]+TX, Bayer 22/190 (development code) (893)+TX, Bayer 22408 (development code) (894)+TX, bendiocarb (58)+TX, benfuracarb (60)+TX, bensultap (66)+TX, beta-cyfluthrin (194)+TX, beta-cypermethrin (203)+TX, bifenthrin (76)+TX, bioallethrin (78)+TX, bioallethrin S-cyclopentenyl isomer (alternative name) (79)+TX, bioethanomethrin [CCN]+TX, biopermethrin (908)+TX, bioresmethrin (80)+TX, bis(2-chloroethyl)ether (IUPAC name) (909)+TX, bistrifluoron (83)+TX, borax (86)+TX, brofenvalerate (alternative name)+TX, bromfenvinfos (914)+TX, bromocyclen (918)+TX, bromo-DDT (alternative name) [CCN]+TX, bromophos (920)+TX, bromophos-ethyl (921)+TX, bufencarb (924)+TX, buprofezin (99)+TX, butacarb (926)+TX, butathiofos (927)+TX, butocarboxim (103)+TX, butonate (932)+TX, butoxycarboxim (104)+TX, butylpyridaben (alternative name)+TX, cadusafos (109)+TX, calcium arsenate [CCN]+TX, calcium cyanide (444)+TX, calcium polysulfide (IUPAC name) (111)+TX, camphechlor (941)+TX, carbanolate (943)+TX, carbaryl (115)+TX, carbofuran (118)+TX, carbon disulfide (IUPAC/Chemical Abstracts name) (945)+TX, carbon tetrachloride (IUPAC name) (946)+TX, carbophenothion (947)+TX, carbosulfan (119)+TX, cartap (123)+TX, cartap hydrochloride (123)+TX, cevadine (alternative name) (725)+TX, chlorbicyclen (960)+TX, chlordane (128)+TX, chlordecone (963)+TX, chlordimeform (964)+TX, chlordimeform hydrochloride (964)+TX, chlorethoxyfos (129)+TX, chlorfenapyr (130)+TX, chlorfenvinphos (131)+TX, chlorfluazuron (132)+TX, chlormephos (136)+TX, chloroform [CCN]+TX, chloropicrin (141)+TX, chlorphoxim (989)+TX, chlorprazophos (990)+TX, chlorpyrifos (145)+TX, chlorpyrifos-methyl (146)+TX, chlorthiophos (994)+TX, chromafenozide (150)+TX, cinerin I (696)+TX, cinerin II (696)+TX, cinerins (696)+TX, cis-resmethrin (alternative name)+TX, cismethrin (80)+TX, clocythrin (alternative name)+TX, cloethocarb (999)+TX, closantel (alternative name) [CCN]+TX, clothianidin (165)+TX, copper acetoarsenite [CCN]+TX, copper arsenate [CCN]+TX, copper oleate [CCN]+TX, coumaphos (174)+TX, coumithoate (1006)+TX, crotamiton (alternative name) [CCN]+TX, crotoxyphos (1010)+TX, crufomate (1011)+TX, cryolite (alternative name) (177)+TX, CS 708 (development code) (1012)+TX, cyanofenphos (1019)+TX, cyanophos (184)+TX, cyanthoate (1020)+TX, cyclethrin [CCN]+TX, cycloprothrin (188)+TX, cyfluthrin (193)+TX, cyhalothrin (196)+TX, cypermethrin (201)+TX, cyphenothrin (206)+TX, cyromazine (209)+TX, cythioate (alternative name) [CCN]+TX, d-limonene (alternative name) [CCN]+TX, d-tetramethrin (alternative name) (788)+TX, DAEP (1031)+TX, dazomet (216)+TX, DDT (219)+TX, decarbofuran (1034)+TX, deltamethrin (223)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-S-methyl (224)+TX, demeton-5-methylsulphon (1039)+TX, diafenthiuron (226)+TX, dialifos (1042)+TX, diamidafos (1044)+TX, diazinon (227)+TX, dicapthon (1050)+TX, dichlofenthion (1051)+TX, dichlorvos (236)+TX, dicliphos (alternative name)+TX, dicresyl (alternative name) [CCN]+TX, dicrotophos (243)+TX, dicyclanil (244)+TX, dieldrin (1070)+TX, diethyl 5-methylpyrazol-3-yl phosphate (IUPAC name) (1076)+TX, diflubenzuron (250)+TX, dilor (alternative name) [CCN]+TX, dimefluthrin [CCN]+TX, dimefox (1081)+TX, dimetan (1085)+TX, dimethoate (262)+TX, dimethrin (1083)+TX, dimethylvinphos (265)+TX, dimetilan (1086)+TX, dinex (1089)+TX, dinex-diclexine (1089)+TX, dinoprop (1093)+TX, dinosam (1094)+TX, dinoseb (1095)+TX, dinotefuran (271)+TX, diofenolan (1099)+TX, dioxabenzofos (1100)+TX, dioxacarb (1101)+TX, dioxathion (1102)+TX, disulfoton (278)+TX, dithicrofos (1108)+TX, DNOC (282)+TX, doramectin (alternative name) [CCN]+TX, DSP (1115)+TX, ecdysterone (alternative name) [CCN]+TX, EI 1642 (development code) (1118)+TX, emamectin (291)+TX, emamectin benzoate (291)+TX, EMPC (1120)+TX, empenthrin (292)+TX, endosulfan (294)+TX, endothion (1121)+TX, endrin (1122)+TX, EPBP (1123)+TX, EPN (297)+TX, epofenonane (1124)+TX, eprinomectin (alternative name) [CCN]+TX, esfenvalerate (302)+TX, etaphos (alternative name) [CCN]+TX, ethiofencarb (308)+TX, ethion (309)+TX, ethiprole (310)+TX, ethoate-methyl (1134)+TX, ethoprophos (312)+TX, ethyl formate (IUPAC name) [CCN]+TX, ethyl-DDD (alternative name) (1056)+TX, ethylene dibromide (316)+TX, ethylene dichloride (chemical name) (1136)+TX, ethylene oxide [CCN]+TX, etofenprox (319)+TX, etrimfos (1142)+TX, EXD (1143)+TX, famphur (323)+TX, fenamiphos (326)+TX, fenazaflor (1147)+TX, fenchlorphos (1148)+TX, fenethacarb (1149)+TX, fenfluthrin (1150)+TX, fenitrothion (335)+TX, fenobucarb (336)+TX, fenoxacrim (1153)+TX, fenoxycarb (340)+TX, fenpirithrin (1155)+TX, fenpropathrin (342)+TX, fenpyrad (alternative name)+TX, fensulfothion (1158)+TX, fenthion (346)+TX, fenthion-ethyl [CCN]+TX, fenvalerate (349)+TX, fipronil (354)+TX, flonicamid (358)+TX, flubendiamide (CAS. Reg. No.: 272451-65-7)+TX, flucofuron (1168)+TX, flucycloxuron (366)+TX, flucythrinate (367)+TX, fluenetil (1169)+TX, flufenerim [CCN]+TX, flufenoxuron (370)+TX, flufenprox (1171)+TX, flumethrin (372)+TX, fluvalinate (1184)+TX, FMC 1137 (development code) (1185)+TX, fonofos (1191)+TX, formetanate (405)+TX, formetanate hydrochloride (405)+TX, formothion (1192)+TX, formparanate (1193)+TX, fosmethilan (1194)+TX, fospirate (1195)+TX, fosthiazate (408)+TX, fosthietan (1196)+TX, furathiocarb (412)+TX, furethrin (1200)+TX, gamma-cyhalothrin (197)+TX, gamma-HCH (430)+TX, guazatine (422)+TX, guazatine acetates (422)+TX, GY-81 (development code) (423)+TX, halfenprox (424)+TX, halofenozide (425)+TX, HCH (430)+TX, HEOD (1070)+TX, heptachlor (1211)+TX, heptenophos (432)+TX, heterophos [CCN]+TX, hexaflumuron (439)+TX, HHDN (864)+TX, hydramethylnon (443)+TX, hydrogen cyanide (444)+TX, hydroprene (445)+TX, hyquincarb (1223)+TX, imidacloprid (458)+TX, imiprothrin (460)+TX, indoxacarb (465)+TX, iodomethane (IUPAC name) (542)+TX, IPSP (1229)+TX, isazofos (1231)+TX, isobenzan (1232)+TX, isocarbophos (alternative name) (473)+TX, isodrin (1235)+TX, isofenphos (1236)+TX, isolane (1237)+TX, isoprocarb (472)+TX, isopropyl O-(methoxyaminothiophosphoryl)salicylate (IUPAC name) (473)+TX, isoprothiolane (474)+TX, isothioate (1244)+TX, isoxathion (480)+TX, ivermectin (alternative name) [CCN]+TX, jasmolin I (696)+TX, jasmolin II (696)+TX, jodfenphos (1248)+TX, juvenile hormone I (alternative name) [CCN]+TX, juvenile hormone II (alternative name) [CCN]+TX, juvenile hormone III (alternative name) [CCN]+TX, kelevan (1249)+TX, kinoprene (484)+TX, lambda-cyhalothrin (198)+TX, lead arsenate [CCN]+TX, lepimectin (CCN)+TX, leptophos (1250)+TX, lindane (430)+TX, lirimfos (1251)+TX, lufenuron (490)+TX, lythidathion (1253)+TX, m-cumenyl methylcarbamate (IUPAC name) (1014)+TX, magnesium phosphide (IUPAC name) (640)+TX, malathion (492)+TX, malonoben (1254)+TX, mazidox (1255)+TX, mecarbam (502)+TX, mecarphon (1258)+TX, menazon (1260)+TX, mephosfolan (1261)+TX, mercurous chloride (513)+TX, mesulfenfos (1263)+TX, metaflumizone (CCN)+TX, metam (519)+TX, metam-potassium (alternative name) (519)+TX, metam-sodium (519)+TX, methacrifos (1266)+TX, methamidophos (527)+TX, methanesulphonyl fluoride (IUPAC/Chemical Abstracts name) (1268)+TX, methidathion (529)+TX, methiocarb (530)+TX, methocrotophos (1273)+TX, methomyl (531)+TX, methoprene (532)+TX, methoquin-butyl (1276)+TX, methothrin (alternative name) (533)+TX, methoxychlor (534)+TX, methoxyfenozide (535)+TX, methyl bromide (537)+TX, methyl isothiocyanate (543)+TX, methylchloroform (alternative name) [CCN]+TX, methylene chloride [CCN]+TX, metofluthrin [CCN]+TX, metolcarb (550)+TX, metoxadiazone (1288)+TX, mevinphos (556)+TX, mexacarbate (1290)+TX, milbemectin (557)+TX, milbemycin oxime (alternative name) [CCN]+TX, mipafox (1293)+TX, mirex (1294)+TX, monocrotophos (561)+TX, morphothion (1300)+TX, moxidectin (alternative name) [CCN]+TX, naftalofos (alternative name) [CCN]+TX, naled (567)+TX, naphthalene (IUPAC/Chemical Abstracts name) (1303)+TX, NC-170 (development code) (1306)+TX, NC-184 (compound code)+TX, nicotine (578)+TX, nicotine sulfate (578)+TX, nifluridide (1309)+TX, nitenpyram (579)+TX, nithiazine (1311)+TX, nitrilacarb (1313)+TX, nitrilacarb 1:1 zinc chloride complex (1313)+TX, NNI-0101 (compound code)+TX, NNI-0250 (compound code)+TX, nornicotine (traditional name) (1319)+TX, novaluron (585)+TX, noviflumuron (586)+TX, O-5-dichloro-4-iodophenyl O-ethyl ethylphosphonothioate (IUPAC name) (1057)+TX, O, O-diethyl O-4-methyl-2-oxo-2H-chromen-7-yl phosphorothioate (IUPAC name) (1074)+TX, O,O-diethyl O-6-methyl-2-propylpyrimidin-4-yl phosphorothioate (IUPAC name) (1075)+TX, O,O,O′,O′-tetrapropyl dithiopyrophosphate (IUPAC name) (1424)+TX, oleic acid (IUPAC name) (593)+TX, omethoate (594)+TX, oxamyl (602)+TX, oxydemeton-methyl (609)+TX, oxydeprofos (1324)+TX, oxydisulfoton (1325)+TX, pp′-DDT (219)+TX, para-dichlorobenzene [CCN]+TX, parathion (615)+TX, parathion-methyl (616)+TX, penfluoron (alternative name) [CCN]+TX, pentachlorophenol (623)+TX, pentachlorophenyl laurate (IUPAC name) (623)+TX, permethrin (626)+TX, petroleum oils (alternative name) (628)+TX, PH 60-38 (development code) (1328)+TX, phenkapton (1330)+TX, phenothrin (630)+TX, phenthoate (631)+TX, phorate (636)+TX, phosalone (637)+TX, phosfolan (1338)+TX, phosmet (638)+TX, phosnichlor (1339)+TX, phosphamidon (639)+TX, phosphine (IUPAC name) (640)+TX, phoxim (642)+TX, phoxim-methyl (1340)+TX, pirimetaphos (1344)+TX, pirimicarb (651)+TX, pirimiphos-ethyl (1345)+TX, pirimiphos-methyl (652)+TX, polychlorodicyclopentadiene isomers (IUPAC name) (1346)+TX, polychloroterpenes (traditional name) (1347)+TX, potassium arsenite [CCN]+TX, potassium thiocyanate [CCN]+TX, prallethrin (655)+TX, precocene I (alternative name) [CCN]+TX, precocene II (alternative name) [CCN]+TX, precocene III (alternative name) [CCN]+TX, primidophos (1349)+TX, profenofos (662)+TX, profluthrin [CCN]+TX, promacyl (1354)+TX, promecarb (1355)+TX, propaphos (1356)+TX, propetamphos (673)+TX, propoxur (678)+TX, prothidathion (1360)+TX, prothiofos (686)+TX, prothoate (1362)+TX, protrifenbute [CCN]+TX, pymetrozine (688)+TX, pyraclofos (689)+TX, pyrazophos (693)+TX, pyresmethrin (1367)+TX, pyrethrin I (696)+TX, pyrethrin II (696)+TX, pyrethrins (696)+TX, pyridaben (699)+TX, pyridalyl (700)+TX, pyridaphenthion (701)+TX, pyrimidifen (706)+TX, pyrimitate (1370)+TX, pyriproxyfen (708)+TX, quassia (alternative name) [CCN]+TX, quinalphos (711)+TX, quinalphos-methyl (1376)+TX, quinothion (1380)+TX, quintiofos (1381)+TX, R-1492 (development code) (1382)+TX, rafoxanide (alternative name) [CCN]+TX, resmethrin (719)+TX, rotenone (722)+TX, RU 15525 (development code) (723)+TX, RU 25475 (development code) (1386)+TX, ryania (alternative name) (1387)+TX, ryanodine (traditional name) (1387)+TX, sabadilla (alternative name) (725)+TX, schradan (1389)+TX, sebufos (alternative name)+TX, selamectin (alternative name) [CCN]+TX, SI-0009 (compound code)+TX, SI-0205 (compound code)+TX, SI-0404 (compound code)+TX, SI-0405 (compound code)+TX, silafluofen (728)+TX, SN 72129 (development code) (1397)+TX, sodium arsenite [CCN]+TX, sodium cyanide (444)+TX, sodium fluoride (IUPAC/Chemical Abstracts name) (1399)+TX, sodium hexafluorosilicate (1400)+TX, sodium pentachlorophenoxide (623)+TX, sodium selenate (IUPAC name) (1401)+TX, sodium thiocyanate [CCN]+TX, sophamide (1402)+TX, spinosad (737)+TX, spiromesifen (739)+TX, spirotetrmat (CCN)+TX, sulcofuron (746)+TX, sulcofuron-sodium (746)+TX, sulfluramid (750)+TX, sulfotep (753)+TX, sulphuryl fluoride (756)+TX, sulprofos (1408)+TX, tar oils (alternative name) (758)+TX, tau-fluvalinate (398)+TX, tazimcarb (1412)+TX, TDE (1414)+TX, tebufenozide (762)+TX, tebufenpyrad (763)+TX, tebupirimfos (764)+TX, teflubenzuron (768)+TX, tefluthrin (769)+TX, temephos (770)+TX, TEPP (1417)+TX, terallethrin (1418)+TX, terbam (alternative name)+TX, terbufos (773)+TX, tetrachloroethane [CCN]+TX, tetrachlorvinphos (777)+TX, tetramethrin (787)+TX, theta-cypermethrin (204)+TX, thiacloprid (791)+TX, thiafenox (alternative name)+TX, thiamethoxam (792)+TX, thicrofos (1428)+TX, thiocarboxime (1431)+TX, thiocyclam (798)+TX, thiocyclam hydrogen oxalate (798)+TX, thiodicarb (799)+TX, thiofanox (800)+TX, thiometon (801)+TX, thionazin (1434)+TX, thiosultap (803)+TX, thiosultap-sodium (803)+TX, thuringiensin (alternative name) [CCN]+TX, tolfenpyrad (809)+TX, tralomethrin (812)+TX, transfluthrin (813)+TX, transpermethrin (1440)+TX, triamiphos (1441)+TX, triazamate (818)+TX, triazophos (820)+TX, triazuron (alternative name)+TX, trichlorfon (824)+TX, trichlormetaphos-3 (alternative name) [CCN]+TX, trichloronat (1452)+TX, trifenofos (1455)+TX, triflumuron (835)+TX, trimethacarb (840)+TX, triprene (1459)+TX, vamidothion (847)+TX, vaniliprole [CCN]+TX, veratridine (alternative name) (725)+TX, veratrine (alternative name) (725)+TX, XMC (853)+TX, xylylcarb (854)+TX, yl-5302 (compound code)+TX, zeta-cypermethrin (205)+TX, zetamethrin (alternative name)+TX, zinc phosphide (640)+TX, zolaprofos (1469) and ZXI 8901 (development code) (858)+TX, cyantraniliprole [736994-63-19]+TX, chlorantraniliprole [500008-45-7]+TX, cyenopyrafen [560121-52-0]+TX, cyflumetofen [400882-07-7]+TX, pyrifluquinazon [337458-27-2]+TX, spinetoram [187166-40-1+187166-15-0]+TX, spirotetramat [203313-25-1]+TX, sulfoxaflor [946578-00-3]+TX, flufiprole [704886-18-0]+TX, meperfluthrin [915288-13-0]+TX, tetramethylfluthrin [84937-88-2]+TX,
a molluscicide selected from the group of substances consisting of bis(tributyltin) oxide (IUPAC name) (913)+TX, bromoacetamide [CCN]+TX, calcium arsenate [CCN]+TX, cloethocarb (999)+TX, copper acetoarsenite [CCN]+TX, copper sulfate (172)+TX, fentin (347)+TX, ferric phosphate (IUPAC name) (352)+TX, metaldehyde (518)+TX, methiocarb (530)+TX, niclosamide (576)+TX, niclosamide-olamine (576)+TX, pentachlorophenol (623)+TX, sodium pentachlorophenoxide (623)+TX, tazimcarb (1412)+TX, thiodicarb (799)+TX, tributyltin oxide (913)+TX, trifenmorph (1454)+TX, trimethacarb (840)+TX, triphenyltin acetate (IUPAC name) (347) and triphenyltin hydroxide (IUPAC name) (347)+TX, pyriprole [394730-71-3]+TX,
a nematicide selected from the group of substances consisting of AKD-3088 (compound code)+TX, 1,2-dibromo-3-chloropropane (IUPAC/Chemical Abstracts name) (1045)+TX, 1,2-dichloropropane (IUPAC/Chemical Abstracts name) (1062)+TX, 1,2-dichloropropane with 1,3-dichloropropene (IUPAC name) (1063)+TX, 1,3-dichloropropene (233)+TX, 3,4-dichlorotetrahydrothiophene 1,1-dioxide (IUPAC/Chemical Abstracts name) (1065)+TX, 3-(4-chlorophenyl)-5-methylrhodanine (IUPAC name) (980)+TX, 5-methyl-6-thioxo-1,3,5-thiadiazinan-3-ylacetic acid (IUPAC name) (1286)+TX, 6-isopentenylaminopurine (alternative name) (210)+TX, abamectin (1)+TX, acetoprole [CCN]+TX, alanycarb (15)+TX, aldicarb (16)+TX, aldoxycarb (863)+TX, AZ 60541 (compound code)+TX, benclothiaz [CCN]+TX, benomyl (62)+TX, butylpyridaben (alternative name)+TX, cadusafos (109)+TX, carbofuran (118)+TX, carbon disulfide (945)+TX, carbosulfan (119)+TX, chloropicrin (141)+TX, chlorpyrifos (145)+TX, cloethocarb (999)+TX, cytokinins (alternative name) (210)+TX, dazomet (216)+TX, DBCP (1045)+TX, DCIP (218)+TX, diamidafos (1044)+TX, dichlofenthion (1051)+TX, dicliphos (alternative name)+TX, dimethoate (262)+TX, doramectin (alternative name) [CCN]+TX, emamectin (291)+TX, emamectin benzoate (291)+TX, eprinomectin (alternative name) [CCN]+TX, ethoprophos (312)+TX, ethylene dibromide (316)+TX, fenamiphos (326)+TX, fenpyrad (alternative name)+TX, fensulfothion (1158)+TX, fosthiazate (408)+TX, fosthietan (1196)+TX, furfural (alternative name) [CCN]+TX, GY-81 (development code) (423)+TX, heterophos [CCN]+TX, iodomethane (IUPAC name) (542)+TX, isamidofos (1230)+TX, isazofos (1231)+TX, ivermectin (alternative name) [CCN]+TX, kinetin (alternative name) (210)+TX, mecarphon (1258)+TX, metam (519)+TX, metam-potassium (alternative name) (519)+TX, metam-sodium (519)+TX, methyl bromide (537)+TX, methyl isothiocyanate (543)+TX, milbemycin oxime (alternative name) [CCN]+TX, moxidectin (alternative name) [CCN]+TX, Myrothecium verrucaria composition (alternative name) (565)+TX, NC-184 (compound code)+TX, oxamyl (602)+TX, phorate (636)+TX, phosphamidon (639)+TX, phosphocarb [CCN]+TX, sebufos (alternative name)+TX, selamectin (alternative name) [CCN]+TX, spinosad (737)+TX, terbam (alternative name)+TX, terbufos (773)+TX, tetrachlorothiophene (IUPAC/Chemical Abstracts name) (1422)+TX, thiafenox (alternative name)+TX, thionazin (1434)+TX, triazophos (820)+TX, triazuron (alternative name)+TX, xylenols [CCN]+TX, yl-5302 (compound code) and zeatin (alternative name) (210)+TX, fluensulfone [318290-98-1]+TX,
a nitrification inhibitor selected from the group of substances consisting of potassium ethylxanthate [CCN] and nitrapyrin (580)+TX,
a plant activator selected from the group of substances consisting of acibenzolar (6)+TX, acibenzolar-5-methyl (6)+TX, probenazole (658) and Reynoutria sachalinensis extract (alternative name) (720)+TX,
a rodenticide selected from the group of substances consisting of 2-isovalerylindan-1,3-dione (IUPAC name) (1246)+TX, 4-(quinoxalin-2-ylamino)benzenesulfonamide (IUPAC name) (748)+TX, alpha-chlorohydrin [CCN]+TX, aluminium phosphide (640)+TX, antu (880)+TX, arsenous oxide (882)+TX, barium carbonate (891)+TX, bisthiosemi (912)+TX, brodifacoum (89)+TX, bromadiolone (91)+TX, bromethalin (92)+TX, calcium cyanide (444)+TX, chloralose (127)+TX, chlorophacinone (140)+TX, cholecalciferol (alternative name) (850)+TX, coumachlor (1004)+TX, coumafuryl (1005)+TX, coumatetralyl (175)+TX, crimidine (1009)+TX, difenacoum (246)+TX, difethialone (249)+TX, diphacinone (273)+TX, ergocalciferol (301)+TX, flocoumafen (357)+TX, fluoroacetamide (379)+TX, flupropadine (1183)+TX, flupropadine hydrochloride (1183)+TX, gamma-HCH (430)+TX, HCH (430)+TX, hydrogen cyanide (444)+TX, iodomethane (IUPAC name) (542)+TX, lindane (430)+TX, magnesium phosphide (IUPAC name) (640)+TX, methyl bromide (537)+TX, norbormide (1318)+TX, phosacetim (1336)+TX, phosphine (IUPAC name) (640)+TX, phosphorus [CCN]+TX, pindone (1341)+TX, potassium arsenite [CCN]+TX, pyrinuron (1371)+TX, scilliroside (1390)+TX, sodium arsenite [CCN]+TX, sodium cyanide (444)+TX, sodium fluoroacetate (735)+TX, strychnine (745)+TX, thallium sulfate [CCN]+TX, warfarin (851) and zinc phosphide (640)+TX,
a synergist selected from the group of substances consisting of 2-(2-butoxyethoxy)ethyl piperonylate (IUPAC name) (934)+TX, 5-(1,3-benzodioxol-5-yl)-3-hexylcyclohex-2-enone (IUPAC name) (903)+TX, farnesol with nerolidol (alternative name) (324)+TX, MB-599 (development code) (498)+TX, MGK 264 (development code) (296)+TX, piperonyl butoxide (649)+TX, piprotal (1343)+TX, propyl isomer (1358)+TX, S421 (development code) (724)+TX, sesamex (1393)+TX, sesasmolin (1394) and sulfoxide (1406)+TX,
an animal repellent selected from the group of substances consisting of anthraquinone (32)+TX, chloralose (127)+TX, copper naphthenate [CCN]+TX, copper oxychloride (171)+TX, diazinon (227)+TX, dicyclopentadiene (chemical name) (1069)+TX, guazatine (422)+TX, guazatine acetates (422)+TX, methiocarb (530)+TX, pyridin-4-amine (IUPAC name) (23)+TX, thiram (804)+TX, trimethacarb (840)+TX, zinc naphthenate [CCN] and ziram (856)+TX,
a virucide selected from the group of substances consisting of imanin (alternative name) [CCN] and ribavirin (alternative name) [CCN]+TX,
a wound protectant selected from the group of substances consisting of mercuric oxide (512)+TX, octhilinone (590) and thiophanate-methyl (802)+TX,
and biologically active compounds selected from the group consisting of azaconazole (60207-31-0]+TX, bitertanol [70585-36-3]+TX, bromuconazole [116255-48-2]+TX, cyproconazole [94361-06-5]+TX, difenoconazole [119446-68-3]+TX, diniconazole [83657-24-3]+TX, epoxiconazole [106325-08-0]+TX, fenbuconazole [114369-43-6]+TX, fluquinconazole [136426-54-5]+TX, flusilazole [85509-19-9]+TX, flutriafol [76674-21-0]+TX, hexaconazole [79983-71-4]+TX, imazalil [35554-44-0]+TX, imibenconazole [86598-92-7]+TX, ipconazole [125225-28-7]+TX, metconazole [125116-23-6]+TX, myclobutanil [88671-89-0]+TX, pefurazoate [101903-30-4]+TX, penconazole [66246-88-6]+TX, prothioconazole [178928-70-6]+TX, pyrifenox [88283-41-4]+TX, prochloraz [67747-09-5]+TX, propiconazole [60207-90-1]+TX, simeconazole [149508-90-7]+TX, tebuconazole [107534-96-3]+TX, tetraconazole [112281-77-3]+TX, triadimefon [43121-43-3]+TX, triadimenol [55219-65-3]+TX, triflumizole [99387-89-0]+TX, triticonazole [131983-72-7]+TX, ancymidol [12771-68-5]+TX, fenarimol [60168-88-9]+TX, nuarimol [63284-71-9]+TX, bupirimate [41483-43-6]+TX, dimethirimol [5221-53-4]+TX, ethirimol [23947-60-6]+TX, dodemorph [1593-77-7]+TX, fenpropidine [67306-00-7]+TX, fenpropimorph [67564-91-4]+TX, spiroxamine [118134-30-8]+TX, tridemorph [81412-43-3]+TX, cyprodinil [121552-61-2]+TX, mepanipyrim [110235-47-7]+TX, pyrimethanil [53112-28-0]+TX, fenpiclonil [74738-17-3]+TX, fludioxonil [131341-86-1]+TX, benalaxyl [71626-11-4]+TX, furalaxyl [57646-30-7]+TX, metalaxyl [57837-19-1]+TX, R-metalaxyl [70630-17-0]+TX, ofurace [58810-48-3]+TX, oxadixyl [77732-09-3]+TX, benomyl [17804-35-2]+TX, carbendazim [10605-21-7]+TX, debacarb [62732-91-6]+TX, fuberidazole [3878-19-1]+TX, thiabendazole [148-79-8]+TX, chlozolinate [84332-86-5]+TX, dichlozoline [24201-58-9]+TX, iprodione [36734-19-7]+TX, myclozoline [54864-61-8]+TX, procymidone [32809-16-8]+TX, vinclozoline [50471-44-8]+TX, boscalid [188425-85-6]+TX, carboxin [5234-68-4]+TX, fenfuram [24691-80-3]+TX, flutolanil [66332-96-5]+TX, mepronil [55814-41-0]+TX, oxycarboxin [5259-88-1]+TX, penthiopyrad [183675-82-3]+TX, thifluzamide [130000-40-7]+TX, guazatine [108173-90-6]+TX, dodine [2439-10-3][112-65-2](free base)+TX, iminoctadine [13516-27-3]+TX, azoxystrobin [131860-33-8]+TX, dimoxystrobin [149961-52-4]+TX, enestroburin {Proc. BCPC, Int. Congr., Glasgow, 2003, 1, 93}+TX, fluoxastrobin [361377-29-9]+TX, kresoxim-methyl [143390-89-0]+TX, metominostrobin [133408-50-1]+TX, trifloxystrobin [141517-21-7]+TX, orysastrobin [248593-16-0]+TX, picoxystrobin [117428-22-5]+TX, pyraclostrobin [175013-18-0]+TX, ferbam [14484-64-1]+TX, mancozeb [8018-01-7]+TX, maneb [12427-38-2]+TX, metiram [9006-42-2]+TX, propineb [12071-83-9]+TX, thiram [137-26-8]+TX, zineb [12122-67-7]+TX, ziram [137-30-4]+TX, captafol [2425-06-1]+TX, captan [133-06-2]+TX, dichlofluanid [1085-98-9]+TX, fluoroimide [41205-21-4]+TX, folpet [133-07-3]+TX, tolylfluanid [731-27-1]+TX, bordeaux mixture [8011-63-0]+TX, copperhydroxid [20427-59-2]+TX, copperoxychlorid [1332-40-7]+TX, coppersulfat [7758-98-7]+TX, copperoxid [1317-39-1]+TX, mancopper [53988-93-5]+TX, oxine-copper [10380-28-6]+TX, dinocap [131-72-6]+TX, nitrothal-isopropyl [10552-74-6]+TX, edifenphos [17109-49-8]+TX, iprobenphos [26087-47-8]+TX, isoprothiolane [50512-35-1]+TX, phosdiphen [36519-00-3]+TX, pyrazophos [13457-18-6]+TX, tolclofos-methyl [57018-04-9]+TX, acibenzolar-5-methyl [135158-54-2]+TX, anilazine [101-05-3]+TX, benthiavalicarb [413615-35-7]+TX, blasticidin-S [2079-00-7]+TX, chinomethionat [2439-01-2]+TX, chloroneb [2675-77-6]+TX, chlorothalonil [1897-45-6]+TX, cyflufenamid [180409-60-3]+TX, cymoxanil [57966-95-7]+TX, dichlone [117-80-6]+TX, diclocymet [139920-32-4]+TX, diclomezine [62865-36-5]+TX, dicloran [99-30-9]+TX, diethofencarb [87130-20-9]+TX, dimethomorph [110488-70-5]+TX, SYP-LI90 (Flumorph) [211867-47-9]+TX, dithianon [3347-22-6]+TX, ethaboxam [162650-77-3]+TX, etridiazole [2593-15-9]+TX, famoxadone [131807-57-3]+TX, fenamidone [161326-34-7]+TX, fenoxanil [115852-48-7]+TX, fentin [668-34-8]+TX, ferimzone [89269-64-7]+TX, fluazinam [79622-59-6]+TX, fluopicolide [239110-15-7]+TX, flusulfamide [106917-52-6]+TX, fenhexamid [126833-17-8]+TX, fosetyl-aluminium [39148-24-8]+TX, hymexazol [10004-44-1]+TX, iprovalicarb [140923-17-7]+TX, IKF-916 (Cyazofamid) [120116-88-3]+TX, kasugamycin [6980-18-3]+TX, methasulfocarb [66952-49-6]+TX, metrafenone [220899-03-6]+TX, pencycuron [66063-05-6]+TX, phthalide [27355-22-2]+TX, polyoxins [11113-80-7]+TX, probenazole [27605-76-1]+TX, propamocarb [25606-41-1]+TX, proquinazid [189278-12-4]+TX, pyroquilon [57369-32-1]+TX, quinoxyfen [124495-18-7]+TX, quintozene [82-68-8]+TX, sulphur [7704-34-9]+TX, tiadinil [223580-51-6]+TX, triazoxide [72459-58-6]+TX, tricyclazole [41814-78-2]+TX, triforine [26644-46-2]+TX, validamycin [37248-47-8]+TX, zoxamide (RH7281) [156052-68-5]+TX, mandipropamid [374726-62-2]+TX, isopyrazam [881685-58-1]+TX, sedaxane [874967-67-6]+TX, 3-difluoromethyl-1-methyl-1H-pyrazole-4-carboxylic acid (9-dichloromethylene-1,2,3,4-tetrahydro-1,4-methano-naphthalen-5-yl)-amide (disclosed in WO 2007/048556)+TX, 3-difluoromethyl-1-methyl-1H-pyrazole-4-carboxylic acid [2-(2,4-dichlorophenyl)-2-methoxy-1-methyl-ethyl]-amide (disclosed in WO 2008/148570)+TX, 1-[4-[4-[(5S)-5-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone+TX, 1-[4-[4[5-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone [1003318-67-9], both disclosed in WO 2010/123791, WO 2008/013925, WO 2008/013622 and WO 2011/051243 page 20)+TX, 3-difluoromethyl-1-methyl-1H-pyrazole-4-carboxylic acid (3′,4′,5′-trifluoro-biphenyl-2-yl)-amide (disclosed in WO 2006/087343)+TX, and 1-methyl-2-(2,4,5-trichloro-thiophen-3-yl)-ethyl]+TX.

The references in brackets behind the active ingredients, e.g. [3878-19-1] refer to the Chemical Abstracts Registry number. The above described mixing partners are known. Where the active ingredients are included in “The Pesticide Manual” [The Pesticide Manual—A World Compendium; Thirteenth Edition; Editor: C. D. S. TomLin; The British Crop Protection Council], they are described therein under the entry number given in round brackets hereinabove for the particular compound; for example, the compound “abamectin” is described under entry number (1). Where “[CCN]” is added hereinabove to the particular compound, the compound in question is included in the “Compendium of Pesticide Common Names”, which is accessible on the internet [A. Wood; Compendium of Pesticide Common Names, Copyright ©1995-2011]; for example, the compound “acetoprole” is described under the internet address http://www.alanwood.net/pesticides/acetoprole.html.

Most of the active ingredients described above are referred to hereinabove by a so-called “common name”, the relevant “ISO common name” or another “common name” being used in individual cases. If the designation is not a “common name”, the nature of the designation used instead is given in round brackets for the particular compound; in that case, the IUPAC name, the IUPAC/Chemical Abstracts name, a “chemical name”, a “traditional name”, a “compound name” or a “development code” is used or, if neither one of those designations nor a “common name” is used, an “alternative name” is employed. “CAS Reg. No” means the Chemical Abstracts Registry Number.

The active ingredient mixture of the compounds of formula I selected from table P with active ingredients described above comprises a compound selected from table P and an active ingredient as described above preferably in a mixing ratio of from 100:1 to 1:6000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred, above all in a ratio of 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are understood to include, on the one hand, ratios by weight and also, on other hand, molar ratios.

The mixtures as described above can be used in a method for controlling pests, which comprises applying a composition comprising a mixture as described above to the pests or their environment, with the exception of a method for treatment of the human or animal body by surgery or therapy and diagnostic methods practised on the human or animal body.

The mixtures comprising a compound of formula I selected from table P and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds of formula I selected from table P and the active ingredients as described above is not essential for working the present invention.

The compositions can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compositions according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the compositions, that is the methods of controlling pests of the abovementioned type, such as spraying, atomizing, dusting, brushing on, dressing, scattering or pouring—which are to be selected to suit the intended aims of the prevailing circumstances—and the use of the compositions for controlling pests of the abovementioned type are other subjects of the invention. Typical rates of concentration are between 0.1 and 1000 ppm, preferably between 0.1 and 500 ppm, of active ingredient. The rate of application per hectare is generally 1 to 2000 g of active ingredient per hectare, in particular 10 to 1000 g/ha, preferably 10 to 600 g/ha.

A preferred method of application in the field of crop protection is application to the foliage of the plants (foliar application), it being possible to select frequency and rate of application to match the danger of infestation with the pest in question. Alternatively, the active ingredi-ent can reach the plants via the root system (systemic action), by drenching the locus of the plants with a liquid composition or by incorporating the active ingredient in solid form into the locus of the plants, for example into the soil, for example in the form of granules (soil application). In the case of paddy rice crops, such granules can be metered into the flooded paddy-field.

The compositions according to the invention are also suitable for the protection of plant pro-pagation material, for example seeds, such as fruit, tubers or kernels, or nursery plants, against pests of the abovementioned type. The propagation material can be treated with the compositions prior to planting, for example seed can be treated prior to sowing. Alternatively, the compositions can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention.

The method of the invention comprises applying to the useful plants, the locus thereof or propagation material thereof in admixture or separately, a synergistically effective aggregate amount of a compound of formula (I) and a further, other compound or compositions (e.g. a further, other biocidally active ingredients or compositions).

Some of said combinations according to the invention have a systemic action and can be used as foliar, soil and seed treatment fungicides.

With the combinations according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The combinations of the present invention are of particular interest for controlling a large number of fungi in various useful plants or their seeds, especially in field crops such as potatoes, tobacco and sugarbeets, and wheat, rye, barley, oats, rice, maize, lawns, cotton, soybeans, oil seed rape, pulse crops, sunflower, coffee, sugarcane, fruit and ornamentals in horticulture and viticulture, in vegetables such as cucumbers, beans and cucurbits.

The composition of the invention comprising at least one additional fungicidally active compound in addition to the compound of formula (I) may be formulated and applied and used in the same manner as the fungicidally active compound of formula (I) alone as described above.

The following non-limiting examples illustrate the above-described invention in greater detail without limiting it.

### PREPARATORY EXAMPLES

### Example 1

### Synthesis of 3-{2-[3-(4-Chloro-2-fluoro-phenyl)-5-(2,4-difluoro-phenyl)-isoxazol-4-yl]-oxiranyl}-pyridine

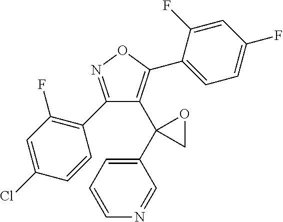 [SMILES: Fc1ccc(-c2onc(-c3ccc(Cl)cc3F)c2C2(c3cccnc3)CO2)c(F)c1]

### Step 1: Synthesis of 3-(2,4-difluoro-phenyl)-1-pyridin-3-yl-propynone

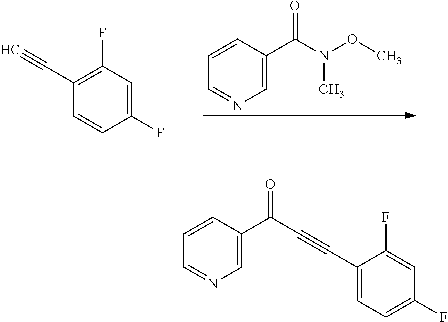

To a solution of 1-ethynyl-2,4-difluorobenzene (16.6 g, 120 mmol, commercially available: Aldrich 556440) in tetrahydrofuran (200 ml) under nitrogen and cooled to −78° C. was added the butyl lithium (2.0 M in cyclohexane, 50 ml, 100 mmol) dropwise. The reaction mixture was stirred at that temperature for 30 minutes and therefore the N-methoxy-N-methyl-nicotinamide (16.6 g, 100 mmol, prepared according to this reference: WO2005097760) diluted in 50 ml of dry tetrahydrofuran was added dropwise. The reaction mixture was stirred at −78° C. for 30 minutes and then allowed to warm to room temperature and then stirred for 2 h. The reaction mixture was quenched with a saturated solution of ammonium chloride (100 ml) and extracted with ethyl acetate (2×200 ml). The combined organic extract were dried over magnesium sulphate, filtered and evaporated under reduced pressure to furnish a brown oil. The crude product was purified by flash chromatography to give 3-(2,4-difluoro-phenyl)-1-pyridin-3-yl-propynone (7.05 g).

### Step 2: Synthesis of [3-(4-chloro-2-fluoro-phenyl)-5-(2,4-difluoro-phenyl)-isoxazol-4-yl]-pyridin-3-yl-methanone

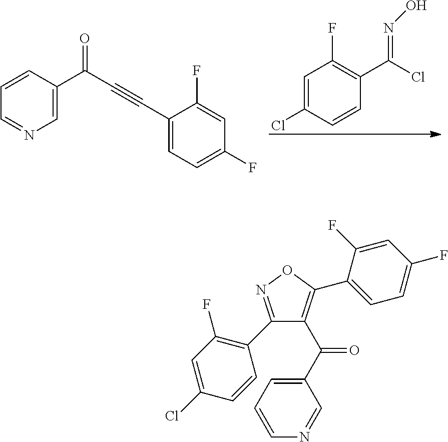 [SMILES: O=C(C#Cc1ccc(F)cc1F)c1cccnc1 ; O/N=C(\Cl)c1ccc(Cl)cc1F ; O=C(c1cccnc1)c1c(-c2ccc(Cl)cc2F)noc1-c1ccc(F)cc1F]

A solution of 3-(2,4-difluoro-phenyl)-1-pyridin-3-yl-propynone (22 g, 106 mmol, prepared according to this reference: US2009/143371) and sodium hydrogen carbonate (10.3 g, 123 mmol) were mixed together in isopropanol (500 ml). The reaction mixture was heated at 68° C. overnight. The reaction mixture was cooled down and concentrated under reduced pressure. The residue was dissolved in EtOAc (200 ml) and brine (200 ml). The organic phase was separated and the aqueous phase was extracted with ethyl acetate (2×200 ml). The combined organic layers were washed with brine (2×100 ml), dried over sodium sulphate, filtered and concentrated under pressure. The solid residue was stirred in diethyl ether and filtered to give 13 g of [3-(4-chloro-2-fluoro-phenyl)-5-(2,4-difluoro-phenyl)-isoxazol-4-yl]-pyridin-3-yl-methanone.

### Step 3: Synthesis of 3-{2-[3-(4-chloro-2-fluoro-phenyl)-5-(2,4-difluoro-phenyl)-isoxazol-4-yl]-oxiranyl}-pyridine

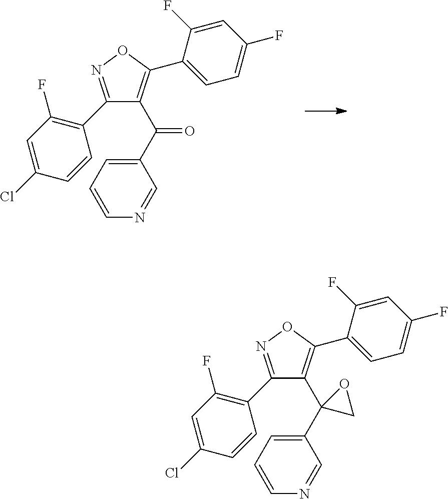 [SMILES: O=C(c1cccnc1)c1c(-c2ccc(Cl)cc2F)noc1-c1ccc(F)cc1F ; Fc1ccc(-c2onc(-c3ccc(Cl)cc3F)c2C2(c3cccnc3)CO2)c(F)c1]

To a solution of [3-(4-chloro-2-fluoro-phenyl)-5-(2,4-difluoro-phenyl)-isoxazol-4-yl]-pyridin-3-yl-methanone (150 mg, 0.36 mmol) in dry acetonitrile (9 ml) was added, under inert atmosphere, potassium hydroxide (48 mg, 0.86 mmol) and trimethyl sulfonium iodide (81 mg, 0.39 mmol). The reaction mixture was therefore stirred at 80° C. for 2.5 hours. The reaction mixture was cooled to room temperature, diluted with ethyl acetate (50 ml), washed with water (10 ml) and with 2N sodium hydroxide (10 ml), dried over sodium sulfate, filtered and evaporated under reduced pressure to give a crude product. The crude product was purified by flash chromatography (heptanes/ethyl acetate: 1/1) to give 3-{2-[3-(4-Chloro-2-fluoro-phenyl)-5-(2,4-difluoro-phenyl)-isoxazol-4-yl]-oxiranyl})-pyridine.

### Example 2

### Synthesis of 3-{2-[3,5-bis-(4-chloro-phenyl)-isothiazol-4-yl]-oxiranyl}-pyridine

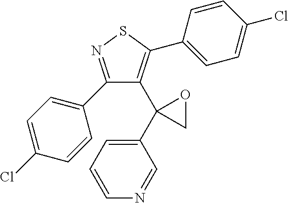 [SMILES: Clc1ccc(-c2nsc(-c3ccc(Cl)cc3)c2C2(c3cccnc3)CO2)cc1]

### Step 1: Synthesis of 5-(4-chloro-phenyl)-[1,3,4]oxathiazol-2-one

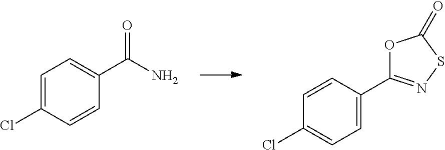 [SMILES: NC(=O)c1ccc(Cl)cc1 ; O=c1oc(-c2ccc(Cl)cc2)ns1]

The 4-chlorobenzamide (12 g, 68.5 mmol; commercially available Aldrich C23802) and chlorocarbonylsulfenyl chloride (10 ml, 102.8 mmol; commercially available Aldrich 247138) in toluene were stirred at 100° C. until gas evolution had nearly ceased. The reaction was then monitored by thin layer chromatography which showed consumption of the starting material. The reaction mixture was then concentrated under reduced pressure and the residue (14.6 g) was used directly for the next step.

### Step 2: Synthesis of [3,5-bis-(4-chloro-phenyl)-isothiazol-4-yl]-pyridin-3-yl-methanone

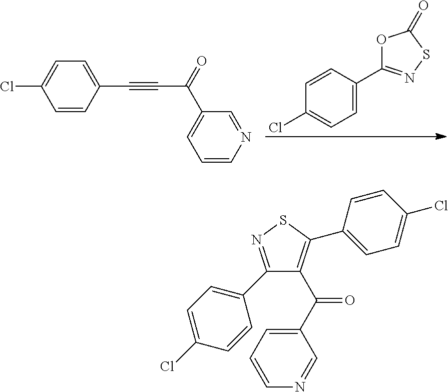

To a stir solution of chlorobenzene (10 ml) with 3-(4-chloro-phenyl)-1-pyridin-3-yl-propynone (1.13 g, 4.7 mmol) was added portion wise aluminum chloride (939 mg, 7 mmol). 5-(4-chloro-phenyl)-[1,3,4]oxathiazol-2-one (1.0 g, 4.7 mmol) was then added and the reaction mixture was heated to 140° C. Once the temperature of 140° C. was reached the reaction mixture was cooled down and quenched using a solution saturated of sodium hydrogen carbonate (50 ml). Dichloromethane (200 ml) was added and the organic phase was then isolated and concentrated under vacuum. The crude product obtained was purified by flash chromatography (gradient from pure cyclohexane to cyclohexane/ethyl acetate: 7/3) to give 410 mg of [3,5-bis-(4-chloro-phenyl)-isothiazol-4-yl]-pyridin-3-yl-methanone.

### Step 3: Synthesis of 3-{2-[3,5-bis-(4-chloro-phenyl)-isothiazol-4-yl]-oxiranyl}-pyridine

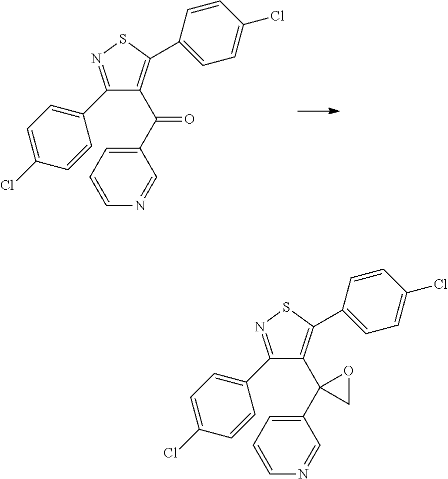 [SMILES: O=C(c1cccnc1)c1c(-c2ccc(Cl)cc2)nsc1-c1ccc(Cl)cc1 ; Clc1ccc(-c2nsc(-c3ccc(Cl)cc3)c2C2(c3cccnc3)CO2)cc1]

Sodium hydride (60% dispersion in mineral oil, 11 mg, 0.27 mmol) was placed under nitrogen then dimethyl sulfoxide (2 ml) was added. Trimethylsulfonium iodide 855 mg, 0.27 mmol) was added as a solid after 15 min, followed after a further 30 min by [3,5-bis-(4-chloro-phenyl)-isothiazol-4-yl]-pyridin-3-yl-methanone (100 mg, 0.24 mmol). The reaction mixture was stirred at room temperature for 24 hrs then diluted with ethyl acetate (20 ml) and washed with water (10 ml) and brine (10 ml). The organic phase was dried over magnesium sulphate, filtered and concentrated to give the crude compound. The crude product was purified by flash chromatography to give 3-{2-[3,5-bis-(4-chloro-phenyl)-isothiazol-4-yl]-oxiranyl}-pyridine.

### Example 3

### Synthesis of 3-{2-[2-cyclohexyl-4-(2,4-dichloro-phenyl)-thiophen-3-yl]-oxiranyl}-pyridine

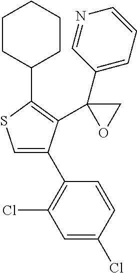 [SMILES: Clc1ccc(-c2csc(C3CCCCC3)c2C2(c3cccnc3)CO2)c(Cl)c1]

### Step 1: Synthesis of [2-cyclohexyl-4-(2,4-dichloro-phenyl)-4-hydroxy-4,5-dihydro-thiophen-3-yl]-pyridin-3-yl-methanone

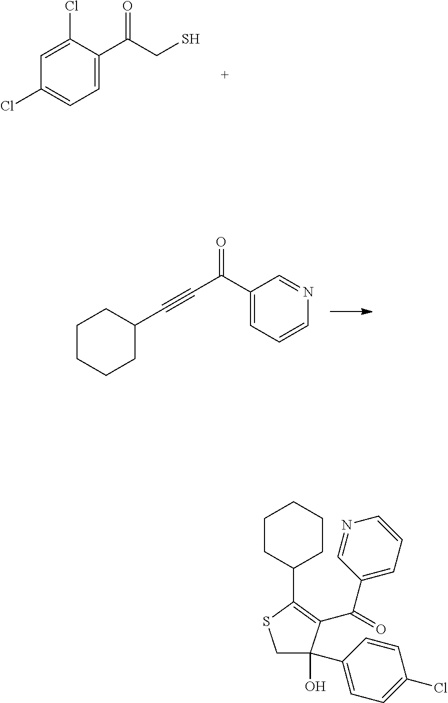 [SMILES: O=C(CS)c1ccc(Cl)cc1Cl ; O=C(C#CC1CCCCC1)c1cccnc1 ; O=C(C1=C(C2CCCCC2)SCC1(O)c1ccc(Cl)cc1)c1cccnc1]

Under nitrogen, to a solution of 1-(2,4-dichloro-phenyl)-2-mercapto-ethanone (6.63 g, 30 mmol) in dimethoxy ethane (200 ml) was added subsequently the 3-cyclohexyl-1-pyridin-3-yl-propynone (5.33 g, 25 mmol), Hunig's base (3.88 g, 30 mmol) and the triphenyl phosphine (984, 3.75 mmol) at room temperature. The reaction mixture was then heated to reflux overnight and cooled to room temperature. The reaction mixture was diluted with ethyl acetate (200 ml) and washed with water (100 ml) and a saturated solution of ammonium chloride (100 ml), dried over magnesium sulfate, filtered and evaporated under reduced pressure to give a brown residue. The residue was without further purification for the next step.

### Step 2: Synthesis of [2-cyclohexyl-4-(2,4-dichloro-phenyl)-thiophen-3-yl]-pyridin-3-yl-methanone

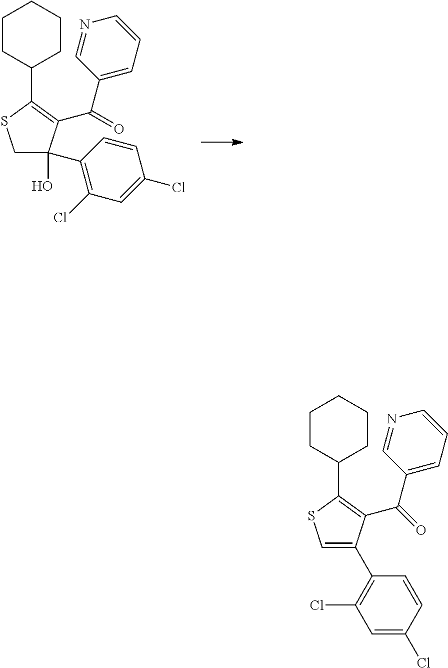 [SMILES: O=C(C1=C(C2CCCCC2)SCC1(O)c1ccc(Cl)cc1Cl)c1cccnc1 ; O=C(c1cccnc1)c1c(-c2ccc(Cl)cc2Cl)csc1C1CCCCC1]

The crude product obtained in the step 1 was dissolved in toluene (150 ml) and p-toluenesulfonic acid was added. The reaction was therefore heated under reflux with removal of water with a Dean-Stark apparatus for 4 hours. The reaction mixture was cooled down to room temperature diluted with ethyl acetate (100 ml) and washed with water (50 ml) and a saturated solution of ammonium chloride, dried over magnesium sulfate, filtered and evaporated under reduced pressure. The crude product was purified by flash chromatography to give of 1.29 g of [2-cyclohexyl-4-(2,4-dichloro-phenyl)-thiophen-3-yl]-pyridin-3-yl-methanone.

### Step 3: Synthesis of 3-{2-[2-cyclohexyl-4-(2,4-dichloro-phenyl)-thiophen-3-yl]-oxiranyl}-pyridine

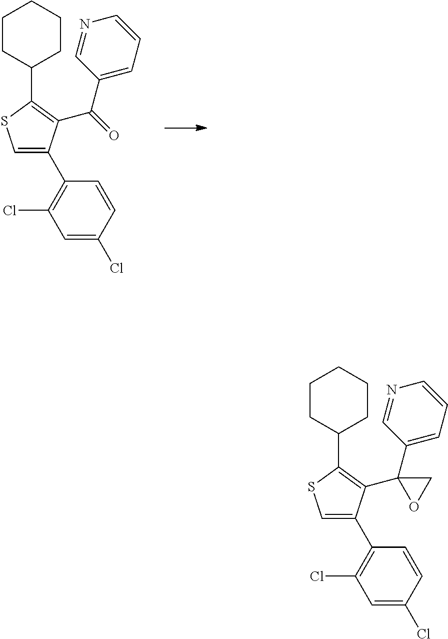 [SMILES: O=C(c1cccnc1)c1c(-c2ccc(Cl)cc2Cl)csc1C1CCCCC1 ; Clc1ccc(-c2csc(C3CCCCC3)c2C2(c3cccnc3)CO2)c(Cl)c1]

Sodium hydride (60% dispersion in mineral oil, 40 mg, 1 mmol) was placed under nitrogen then dry dimethyl sulfoxide (2 ml) was added. Trimethylsulfonium iodide (204 mg, 1 mmol) was added as a solid after 15 minutes, followed after a further 30 minutes by [2-cyclohexyl-4-(2,4-dichloro-phenyl)-thiophen-3-yl]-pyridin-3-yl-methanone (104 mg, 0.25 mmol). The mixture was stirred at room temperature over the week-end then diluted with ethyl acetate (50 ml) and washed with water/brine (1:2, 15 ml), water (15 ml) and brine (15 ml). The organic phase was dried over MgSO₄, filtered and concentrated to give the crude product. The crude product was purified by flash chromatography to give 3-{2-[2-cyclohexyl-4-(2,4-dichloro-phenyl)-thiophen-3-yl]-oxiranyl}-pyridine.

Additional compounds in Table T1, Table T2 and Table T3 are prepared by similar methods using appropriate starting materials.

TABLE T1
(I)

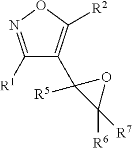

| Com- | | | | | | | Mp |
|---|---|---|---|---|---|---|---|
| pounds | R¹ | R² | R⁶ | R⁷ | R⁵ | LC/MS | (° C.) |
| T1.1 | 4-chloro-2- | 2-chloro- | H | H | 5-pyrimidyl | Rt: 1.90 | |
| | fluoro- | phenyl | | | | min | |
| | phenyl | | | | | M+: | |
| | | | | | | 428/430 | |
| T1.2 | 4-chloro- | n-propyl | H | H | 5-pyrimidyl | Rt: 1.85 | |
| | phenyl | | | | | min | |
| | | | | | | M+: | |
| | | | | | | 342/344 | |
| T1.3 | 4-chloro-2- | 2,4- | H | H | 3-pyridyl | Rt: 1.99 | |
| | fluoro- | difluoro- | | | | min | |
| | phenyl | phenyl | | | | M+: | |
| | | | | | | 429/431 | |
| T1.4 | 4-chloro- | Cl | H | H | 3-pyridyl | Rt: 1.83 | 115- |
| | phenyl | | | | | min | 117 |
| | | | | | | M+: | |
| | | | | | | 333/335 | |
| T1.5 | 4-chloro-2- | 2,4- | H | H | 4-methyl-3- | Rt: 1.87 | |
| | fluoro- | difluoro- | | | pyridyl | min | |
| | phenyl | phenyl | | | | M+: | |
| | | | | | | 443/445 | |

TABLE T2
(I)

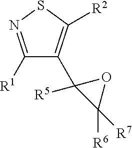

| Com- | | | | | | | Mp |
|---|---|---|---|---|---|---|---|
| pounds | R¹ | R² | R⁶ | R⁷ | R⁵ | LC/MS | (° C.) |
| T2.1 | 4-chloro- | 4-chloro- | H | H | 3- | Rt:2.11 | |
| | phenyl | phenyl | | | pyridyl | min | |
| | | | | | | M+: | |
| | | | | | | 425/427 | |
| T2.2 | 2,4-dichloro- | 2,4-difluoro- | H | H | 3- | Rt:2.01 | |
| | phenyl | phenyl | | | pyridyl | min | |
| | | | | | | M+: | |
| | | | | | | 461/463 | |
| T2.3 | 2-fluoro-4- | 2,4-difluoro- | H | H | 3- | Rt:1.96 | |
| | chloro- | phenyl | | | pyridyl | min | |
| | phenyl | | | | | M+: | |
| | | | | | | 445/447 | |

TABLE T3
(I)

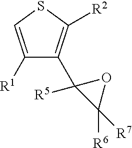

| Com- | | | | | | | Mp |
|---|---|---|---|---|---|---|---|
| pounds | R¹ | R² | R⁶ | R⁷ | R⁵ | LC/MS | (° C.) |
| T3.1 | 2,4-dichloro- | cyclo-hexyl | H | H | 3- | Rt:2.25 | |
| | phenyl | | | | pyridyl | min | |
| | | | | | | M+: | |
| | | | | | | 430/432 | |
| T3.2 | 4-chloro- | 4-chloro- | H | H | 3- | Rt:2.15 | |
| | phenyl | phenyl | | | pyridyl | min | |
| | | | | | | M+: | |
| | | | | | | 424/426 | |
| T3.3 | 2-fluoro-4- | 2,4-difluoro- | H | H | 3- | Rt:2.05 | |
| | chloro- | phenyl | | | pyridyl | min | |
| | phenyl | | | | | M+: | |
| | | | | | | 444/446 | |

The compounds of the following Tables 4 to 12 can be obtained in an analogous manner. Table 4 covers 217 compounds of the following type:

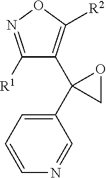

where R¹ and R² are as described in Table 4 below:

| Compounds | R¹ | R² |
|---|---|---|
| T4.1 | 4-chloro-phenyl | phenyl |
| T4.2 | 4-chloro-phenyl | 4-chloro-phenyl |
| T4.3 | 4-chloro-phenyl | 3-chloro-phenyl |
| T4.4 | 4-chloro-phenyl | 2-chloro-phenyl |
| T4.5 | 4-chloro-phenyl | 2,4-dichloro-phenyl |
| T4.6 | 4-chloro-phenyl | 2-thiophenyl |
| T4.7 | 4-chloro-phenyl | 5-chloro-2-thiophenyl |
| T4.8 | 4-chloro-phenyl | 5-bromo-2-thiophenyl |
| T4.9 | 4-chloro-phenyl | 4-fluoro-phenyl |
| T4.10 | 4-chloro-phenyl | 3-fluoro-phenyl |
| T4.11 | 4-chloro-phenyl | 2-fluoro-phenyl |
| T4.12 | 4-chloro-phenyl | 2,4-difluoro-phenyl |
| T4.13 | 4-chloro-phenyl | 2-fluoro-4-chloro-phenyl |
| T4.14 | 4-chloro-phenyl | 2-chloro-4-fluoro-phenyl |
| T4.15 | 4-chloro-phenyl | 4-trifluoromethyl-phenyl |
| T4.16 | 4-chloro-phenyl | 3-trifluoromethyl-phenyl |
| T4.17 | 4-chloro-phenyl | 2-trifluoromethyl-phenyl |
| T4.18 | 4-chloro-phenyl | 4-bromo-phenyl |
| T4.19 | 4-chloro-phenyl | cyclohexyl |
| T4.20 | 4-chloro-phenyl | cyclopentyl |
| T4.21 | 4-chloro-phenyl | Cyclobutyl |
| T4.22 | 4-chloro-phenyl | cyclopropyl |
| T4.23 | 4-chloro-phenyl | tert-butyl |
| T4.24 | 4-chloro-phenyl | sec-butyl |
| T4.25 | 4-chloro-phenyl | Isoamyl |
| T4.26 | 4-chloro-phenyl | iso-propyl |
| T4.27 | 4-chloro-phenyl | Et |
| T4.28 | 4-chloro-phenyl | Me |
| T4.29 | 4-chloro-phenyl | Cl |
| T4.30 | 4-chloro-phenyl | Br |
| T4.31 | 4-chloro-phenyl | CF₃ |
| T4.32 | 4-chloro-2-fluoro-phenyl | phenyl |
| T4.33 | 4-chloro-2-fluoro-phenyl | 4-chloro-phenyl |
| T4.34 | 4-chloro-2-fluoro-phenyl | 3-chloro-phenyl |
| T4.35 | 4-chloro-2-fluoro-phenyl | 2-chloro-phenyl |
| T4.36 | 4-chloro-2-fluoro-phenyl | 2,4-dichloro-phenyl |
| T4.37 | 4-chloro-2-fluoro-phenyl | 2-thiophenyl |
| T4.38 | 4-chloro-2-fluoro-phenyl | 5-chloro-2-thiophenyl |
| T4.39 | 4-chloro-2-fluoro-phenyl | 5-bromo-2-thiophenyl |
| T4.40 | 4-chloro-2-fluoro-phenyl | 4-fluoro-phenyl |
| T4.41 | 4-chloro-2-fluoro-phenyl | 3-fluoro-phenyl |
| T4.42 | 4-chloro-2-fluoro-phenyl | 2-fluoro-phenyl |
| T4.43 | 4-chloro-2-fluoro-phenyl | 2,4-difluoro-phenyl |
| T4.44 | 4-chloro-2-fluoro-phenyl | 2-fluoro-4-chloro-phenyl |
| T4.45 | 4-chloro-2-fluoro-phenyl | 2-chloro-4-fluoro-phenyl |
| T4.46 | 4-chloro-2-fluoro-phenyl | 4-trifluoromethyl-phenyl |
| T4.47 | 4-chloro-2-fluoro-phenyl | 3-trifluoromethyl-phenyl |
| T4.48 | 4-chloro-2-fluoro-phenyl | 2-trifluoromethyl-phenyl |
| T4.49 | 4-chloro-2-fluoro-phenyl | 4-bromo-phenyl |
| T4.50 | 4-chloro-2-fluoro-phenyl | cyclohexyl |
| T4.51 | 4-chloro-2-fluoro-phenyl | cyclopentyl |
| T4.52 | 4-chloro-2-fluoro-phenyl | Cyclobutyl |
| T4.53 | 4-chloro-2-fluoro-phenyl | cyclopropyl |
| T4.54 | 4-chloro-2-fluoro-phenyl | tert-butyl |
| T4.55 | 4-chloro-2-fluoro-phenyl | sec-butyl |
| T4.56 | 4-chloro-2-fluoro-phenyl | Isoamyl |
| T4.57 | 4-chloro-2-fluoro-phenyl | iso-propyl |
| T4.58 | 4-chloro-2-fluoro-phenyl | Et |
| T4.59 | 4-chloro-2-fluoro-phenyl | Me |
| T4.60 | 4-chloro-2-fluoro-phenyl | Cl |
| T4.61 | 4-chloro-2-fluoro-phenyl | Br |
| T4.62 | 4-chloro-2-fluoro-phenyl | CF₃ |
| T4.63 | 2,4-difluoro-phenyl | phenyl |
| T4.64 | 2,4-difluoro-phenyl | 4-chloro-phenyl |
| T4.65 | 2,4-difluoro-phenyl | 3-chloro-phenyl |
| T4.66 | 2,4-difluoro-phenyl | 2-chloro-phenyl |
| T4.67 | 2,4-difluoro-phenyl | 2,4-dichloro-phenyl |
| T4.68 | 2,4-difluoro-phenyl | 2-thiophenyl |
| T4.69 | 2,4-difluoro-phenyl | 5-chloro-2-thiophenyl |
| T4.70 | 2,4-difluoro-phenyl | 5-bromo-2-thiophenyl |
| T4.71 | 2,4-difluoro-phenyl | 4-fluoro-phenyl |
| T4.72 | 2,4-difluoro-phenyl | 3-fluoro-phenyl |
| T4.73 | 2,4-difluoro-phenyl | 2-fluoro-phenyl |
| T4.74 | 2,4-difluoro-phenyl | 2,4-difluoro-phenyl |
| T4.75 | 2,4-difluoro-phenyl | 2-fluoro-4-chloro-phenyl |
| T4.76 | 2,4-difluoro-phenyl | 2-chloro-4-fluoro-phenyl |
| T4.77 | 2,4-difluoro-phenyl | 4-trifluoromethyl-phenyl |
| T4.78 | 2,4-difluoro-phenyl | 3-trifluoromethyl-phenyl |
| T4.79 | 2,4-difluoro-phenyl | 2-trifluoromethyl-phenyl |
| T4.80 | 2,4-difluoro-phenyl | 4-bromo-phenyl |
| T4.81 | 2,4-difluoro-phenyl | cyclohexyl |
| T4.82 | 2,4-difluoro-phenyl | cyclopentyl |
| T4.83 | 2,4-difluoro-phenyl | Cyclobutyl |
| T4.84 | 2,4-difluoro-phenyl | cyclopropyl |
| T4.85 | 2,4-difluoro-phenyl | tert-butyl |
| T4.86 | 2,4-difluoro-phenyl | sec-butyl |
| T4.87 | 2,4-difluoro-phenyl | Isoamyl |
| T4.88 | 2,4-difluoro-phenyl | iso-propyl |
| T4.89 | 2,4-difluoro-phenyl | Et |
| T4.90 | 2,4-difluoro-phenyl | Me |
| T4.91 | 2,4-difluoro-phenyl | Cl |
| T4.92 | 2,4-difluoro-phenyl | Br |
| T4.93 | 2,4-difluoro-phenyl | CF₃ |
| T4.94 | 2,4-dichloro-phenyl | phenyl |
| T4.95 | 2,4-dichloro-phenyl | 4-chloro-phenyl |
| T4.96 | 2,4-dichloro-phenyl | 3-chloro-phenyl |
| T4.97 | 2,4-dichloro-phenyl | 2-chloro-phenyl |
| T4.98 | 2,4-dichloro-phenyl | 2,4-dichloro-phenyl |
| T4.99 | 2,4-dichloro-phenyl | 2-thiophenyl |
| T4.100 | 2,4-dichloro-phenyl | 5-chloro-2-thiophenyl |
| T4.101 | 2,4-dichloro-phenyl | 5-bromo-2-thiophenyl |
| T4.102 | 2,4-dichloro-phenyl | 4-fluoro-phenyl |
| T4.103 | 2,4-dichloro-phenyl | 3-fluoro-phenyl |
| T4.104 | 2,4-dichloro-phenyl | 2-fluoro-phenyl |
| T4.105 | 2,4-dichloro-phenyl | 2,4-difluoro-phenyl |
| T4.106 | 2,4-dichloro-phenyl | 2-fluoro-4-chloro-phenyl |
| T4.107 | 2,4-dichloro-phenyl | 2-chloro-4-fluoro-phenyl |
| T4.108 | 2,4-dichloro-phenyl | 4-trifluoromethyl-phenyl |
| T4.109 | 2,4-dichloro-phenyl | 3-trifluoromethyl-phenyl |
| T4.110 | 2,4-dichloro-phenyl | 2-trifluoromethyl-phenyl |
| T4.111 | 2,4-dichloro-phenyl | 4-bromo-phenyl |
| T4.112 | 2,4-dichloro-phenyl | cyclohexyl |
| T4.113 | 2,4-dichloro-phenyl | cyclopentyl |
| T4.114 | 2,4-dichloro-phenyl | Cyclobutyl |
| T4.115 | 2,4-dichloro-phenyl | cyclopropyl |
| T4.116 | 2,4-dichloro-phenyl | tert-butyl |
| T4.117 | 2,4-dichloro-phenyl | sec-butyl |
| T4.118 | 2,4-dichloro-phenyl | Isoamyl |
| T4.119 | 2,4-dichloro-phenyl | iso-propyl |
| T4.120 | 2,4-dichloro-phenyl | Et |
| T4.121 | 2,4-dichloro-phenyl | Me |
| T4.122 | 2,4-dichloro-phenyl | Cl |
| T4.123 | 2,4-dichloro-phenyl | Br |
| T4.124 | 2,4-dichloro-phenyl | CF₃ |
| T4.125 | 2-fluoro-phenyl | phenyl |
| T4.126 | 2-fluoro-phenyl | 4-chloro-phenyl |
| T4.127 | 2-fluoro-phenyl | 3-chloro-phenyl |
| T4.128 | 2-fluoro-phenyl | 2-chloro-phenyl |
| T4.129 | 2-fluoro-phenyl | 2,4-dichloro-phenyl |
| T4.130 | 2-fluoro-phenyl | 2-thiophenyl |
| T4.131 | 2-fluoro-phenyl | 5-chloro-2-thiophenyl |
| T4.132 | 2-fluoro-phenyl | 5-bromo-2-thiophenyl |
| T4.133 | 2-fluoro-phenyl | 4-fluoro-phenyl |
| T4.134 | 2-fluoro-phenyl | 3-fluoro-phenyl |
| T4.135 | 2-fluoro-phenyl | 2-fluoro-phenyl |
| T4.136 | 2-fluoro-phenyl | 2,4-difluoro-phenyl |
| T4.137 | 2-fluoro-phenyl | 2-fluoro-4-chloro-phenyl |
| T4.138 | 2-fluoro-phenyl | 2-chloro-4-fluoro-phenyl |
| T4.139 | 2-fluoro-phenyl | 4-trifluoromethyl-phenyl |
| T4.140 | 2-fluoro-phenyl | 3-trifluoromethyl-phenyl |
| T4.141 | 2-fluoro-phenyl | 2-trifluoromethyl-phenyl |
| T4.142 | 2-fluoro-phenyl | 4-bromo-phenyl |
| T4.143 | 2-fluoro-phenyl | cyclohexyl |
| T4.144 | 2-fluoro-phenyl | cyclopentyl |
| T4.145 | 2-fluoro-phenyl | Cyclobutyl |
| T4.146 | 2-fluoro-phenyl | cyclopropyl |
| T4.147 | 2-fluoro-phenyl | tert-butyl |
| T4.148 | 2-fluoro-phenyl | sec-butyl |
| T4.149 | 2-fluoro-phenyl | Isoamyl |
| T4.150 | 2-fluoro-phenyl | iso-propyl |
| T4.151 | 2-fluoro-phenyl | Et |
| T4.152 | 2-fluoro-phenyl | Me |
| T4.153 | 2-fluoro-phenyl | Cl |
| T4.154 | 2-fluoro-phenyl | Br |
| T4.155 | 2-fluoro-phenyl | CF₃ |
| T4.156 | 5-chloro-2-thiophenyl | phenyl |
| T4.157 | 5-chloro-2-thiophenyl | 4-chloro-phenyl |
| T4.158 | 5-chloro-2-thiophenyl | 3-chloro-phenyl |
| T4.159 | 5-chloro-2-thiophenyl | 2-chloro-phenyl |
| T4.160 | 5-chloro-2-thiophenyl | 2,4-dichloro-phenyl |
| T4.161 | 5-chloro-2-thiophenyl | 2-thiophenyl |
| T4.162 | 5-chloro-2-thiophenyl | 5-chloro-2-thiophenyl |
| T4.163 | 5-chloro-2-thiophenyl | 5-bromo-2-thiophenyl |
| T4.164 | 5-chloro-2-thiophenyl | 4-fluoro-phenyl |
| T4.165 | 5-chloro-2-thiophenyl | 3-fluoro-phenyl |
| T4.166 | 5-chloro-2-thiophenyl | 2-fluoro-phenyl |
| T4.167 | 5-chloro-2-thiophenyl | 2,4-difluoro-phenyl |
| T4.168 | 5-chloro-2-thiophenyl | 2-fluoro-4-chloro-phenyl |
| T4.169 | 5-chloro-2-thiophenyl | 2-chloro-4-fluoro-phenyl |
| T4.170 | 5-chloro-2-thiophenyl | 4-trifluoromethyl-phenyl |
| T4.171 | 5-chloro-2-thiophenyl | 3-trifluoromethyl-phenyl |
| T4.172 | 5-chloro-2-thiophenyl | 2-trifluoromethyl-phenyl |
| T4.173 | 5-chloro-2-thiophenyl | 4-bromo-phenyl |
| T4.174 | 5-chloro-2-thiophenyl | cyclohexyl |
| T4.175 | 5-chloro-2-thiophenyl | cyclopentyl |
| T4.176 | 5-chloro-2-thiophenyl | Cyclobutyl |
| T4.177 | 5-chloro-2-thiophenyl | cyclopropyl |
| T4.178 | 5-chloro-2-thiophenyl | tert-butyl |
| T4.179 | 5-chloro-2-thiophenyl | sec-butyl |
| T4.180 | 5-chloro-2-thiophenyl | Isoamyl |
| T4.181 | 5-chloro-2-thiophenyl | iso-propyl |
| T4.182 | 5-chloro-2-thiophenyl | Et |
| T4.183 | 5-chloro-2-thiophenyl | Me |
| T4.184 | 5-chloro-2-thiophenyl | Cl |
| T4.185 | 5-chloro-2-thiophenyl | Br |
| T4.186 | 5-chloro-2-thiophenyl | CF₃ |
| T4.187 | cyclohexyl | phenyl |
| T4.188 | cyclohexyl | 4-chloro-phenyl |
| T4.189 | cyclohexyl | 3-chloro-phenyl |
| T4.190 | cyclohexyl | 2-chloro-phenyl |
| T4.191 | cyclohexyl | 2,4-dichloro-phenyl |
| T4.192 | cyclohexyl | 2-thiophenyl |
| T4.193 | cyclohexyl | 5-chloro-2-thiophenyl |
| T4.194 | cyclohexyl | 5-bromo-2-thiophenyl |
| T4.195 | cyclohexyl | 4-fluoro-phenyl |
| T4.196 | cyclohexyl | 3-fluoro-phenyl |
| T4.197 | cyclohexyl | 2-fluoro-phenyl |
| T4.198 | cyclohexyl | 2,4-difluoro-phenyl |
| T4.199 | cyclohexyl | 2-fluoro-4-chloro-phenyl |
| T4.200 | cyclohexyl | 2-chloro-4-fluoro-phenyl |
| T4.201 | cyclohexyl | 4-trifluoromethyl-phenyl |
| T4.202 | cyclohexyl | 3-trifluoromethyl-phenyl |
| T4.203 | cyclohexyl | 2-trifluoromethyl-phenyl |
| T4.204 | cyclohexyl | 4-bromo-phenyl |
| T4.205 | cyclohexyl | cyclohexyl |
| T4.206 | cyclohexyl | cyclopentyl |
| T4.207 | cyclohexyl | Cyclobutyl |
| T4.208 | cyclohexyl | cyclopropyl |
| T4.209 | cyclohexyl | tert-butyl |
| T4.210 | cyclohexyl | sec-butyl |
| T4.211 | cyclohexyl | Isoamyl |
| T4.212 | cyclohexyl | iso-propyl |
| T4.213 | cyclohexyl | Et |
| T4.214 | cyclohexyl | Me |
| T4.215 | cyclohexyl | Cl |
| T4.216 | cyclohexyl | Br |
| T4.217 | cyclohexyl | CF₃ |

Table 5 covers 217 compounds of the following type:

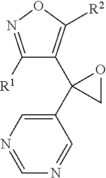

where R¹ and R² are as described in Table 4.

Table 6 covers 217 compounds of the following type:

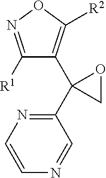

where R¹ and R² are as described in Table 4.

Table 7 covers 217 compounds of the following type:

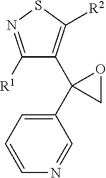

where R¹ and R² are as described in Table 4.

Table 8 covers 217 compounds of the following type:

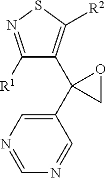

where R¹ and R² are as described in Table 4.

Table 9 covers 217 compounds of the following type:

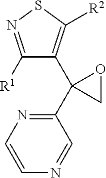

where R¹ and R² are as described in Table 4.

Table 10 covers 217 compounds of the following type:

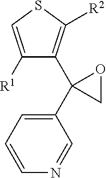

where R¹ and R² are as described in Table 4.

Table 11 covers 217 compounds of the following type:

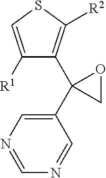

where R¹ and R² are as described in Table 4.

Table 12 covers 217 compounds of the following type:

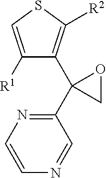

where R¹ and R² are as described in Table 4.

### Biological Examples

These examples illustrate the fungicidal properties of the compounds described in table T1 and T2.

### Description of the Methods:

Botrytis cinerea (Gray Mould):

Conidia of the fungus from cryogenic storage were directly mixed into nutrient broth (PDB potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 72 hrs.

The following compounds give at least 80% control of Botrytis cinerea at 200 ppm: T1.1, T1.2, T1.3, T2.2, T2.3. Septoria tritici (Leaf Blotch):

Conidia of the fungus from cryogenic storage were directly mixed into nutrient broth (PDB potato dextrose broth). After placing a (DMSO) solution of the test compounds into a microtiter plate (96-well format) the nutrient broth containing the fungal spores was added. The test plates were incubated at 24 C and the inhibition of growth was determined photometrically after 72 hrs.

The following compounds give at least 80% control of Septoria tritici at 200 ppm: T1.1, T1.3, T1.4, T1.5, T2.1, T2.2, T2.3, T3.1, T3.2, T3.3.

Puccinia recondita (Brown Rust):

Wheat leaf segments are placed on agar in multiwell plates (24-well format) and sprayed with test solutions. After drying, the leaf disks are inoculated with a spore suspension of the fungus. After appropriate incubation the activity of a compound is assessed 8 dpi (days after inoculation) as preventive fungicidal activity.

The following compounds give at least 80% control of Puccinia recondita at 200 ppm: T1.1, T1.5, T2.2, T2.3.

1. A compound of formula (I) 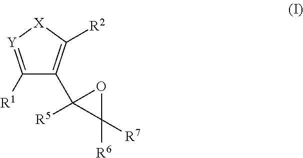
wherein
X is S or O;
Y is C—H or N;
R¹ is unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; or a substituted 5 to 10-membered aromatic heterocycle;
R² is H; halogen, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₁₋₈haloalkyl; substituted C₁₋₈haloalkyl; unsubstituted C₃₋₈cycloalkyl; substituted C₃₋₈cycloalkyl; unsubstituted C₇₋₁₅arylalkyl; substituted C₇₋₁₅arylalkyl; unsubstituted C₆₋₁₀aryloxy-C₁₋₈alkyl; substituted C₆₋₁₀aryloxy-C₁₋₈alkyl; unsubstituted C₆₋₁₀arylthio-C₁₋₈alkyl; substituted C₆₋₁₀arylthio-C₁₋₈alkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; a substituted 5 to 10-membered aromatic heterocycle; unsubstituted C₁₋₈alkylsilyl; or substituted C₁₋₈alkylsilyl;
R⁵ is a unsubstituted 5 to 10 membered aromatic heterocycle; or a substituted 5 to 10 membered aromatic heterocycle;
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; a unsubstituted 5 to 10 membered aromatic heterocycle; or a substituted 5 to 10 membered aromatic heterocycle;
wherein the substituents of the substituted alkyl groups, the substituted alkenyl groups, the substituted alkynyl groups, the substituted alkoxy groups, substituted aryl groups and/or the aromatic heterocycle groups in the compound of formula (I) are selected from the following substituents F, Cl, Br, I, —OH, —CN, nitro, —C₁₋₄alkoxy, —C₁₋₄ alkylthio, C₁₋₄alkyl, C₂₋₄alkenyl, C₂₋₄alkenyl, C₂₋₄alkynyl, —C(O)H, —C(O)(C₁₋₄ alkyl), —C(O)(C₁₋₄ alkoxy), —C(O)NH₂, —C(O)NH(C₁₋₄ alkyl), —C(O)N(C₁₋₄ alkyl)(C₁₋₄alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄ alkyl)₃, —Si(C₁₋₄ alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₂₋₆alkynyl, —C₂₋₆alkenyl, heteroarylC₂₋₆alkynyl, —C₂₋₆alkenyl, C₃₋₈cycloalkyl; —NR⁸R⁹ where R⁸ and R⁹ are independently H, —C₁₋₄alkyl-C₂₋₄alkenyl, —C₂₋₄alkynyl or combine with the interjacent nitrogen to form a five- or six-membered ring which may comprise one or two or three heteroatoms (one or two N, O or S atoms in addition to the interjacent nitrogen atom), in which case the heterocyclic ring is unsubstituted or the heterocyclic ring is substituted by one or two C₁₋₄ alkyl groups, —C₂₋₄alkenyl or substituted —C₂₋₄alkenyl, —C₂₋₄alkynyl or substituted —C₂₋₄alkynyl, —C(O)H, —C(O)(C₁₋₄ alkyl), —C(O)(C₁₋₄ alkoxy), —C(O)NH₂, —C(O)NH(C₁₋₄alkyl), —C(O)N(C₁₋₄alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄ alkyl)₃, —Si(C₁₋₄ alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₁₋₄alkynyl, —C₁₋₆alkynyl, wherein all the alkyl, alkenyl, alkynyl, alkoxy, aryl, aryloxy, arylthio or heteroaryl groups are either substituted or unsubstituted, preferably these substituents of the substituted groups bear only one further substituent, more preferably these substituents of the substituted groups are not further substituted.

2. A compounds according to claim 1 characterized in that
X is S or O;
Y is C—H or N;
R¹ is unsubstituted C₁₋₈alkyl; substituted C₁₋₈alkyl; unsubstituted C₁₋₈alkenyl; substituted C₁₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted C₃₋₈cycloalkyl; substituted C₃₋₈cycloalkyl; unsubstituted C₁₋₈haloalkyl; substituted C₁₋₈haloalkyl; unsubstituted C₇₋₁₅arylalkyl; substituted C₇₋₁₅arylalkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; or a substituted 5 to 10-membered aromatic heterocycle;
R² is H; halogen, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; unsubstituted C₁₋₈alkoxyalkyl; substituted C₁₋₈alkoxyalkyl; unsubstituted Cl₁₋₈haloalkyl; substituted C₁₋₈haloalkyl; unsubstituted C₃₋₈cycloalkyl; substituted C₃₋₈cycloalkyl; unsubstituted C₇₋₁₅arylalkyl; substituted C₇₋₁₅arylalkyl; unsubstituted C₆₋₁₀aryloxy-C₁₋₈alkyl; substituted C₆₋₁₀aryloxy-C₁₋₈alkyl; unsubstituted C₆₋₁₀arylthio-C₁₋₈alkyl; substituted C₆₋₁₀arylthio-C₁₋₈alkyl; unsubstituted C₆₋₁₀aryl; substituted C₆₋₁₀aryl; unsubstituted C₆₋₁₀aryloxy; substituted C₆₋₁₀aryloxy; unsubstituted C₆₋₁₀arylthio; substituted C₆₋₁₀arylthio; a unsubstituted 5 to 10-membered aromatic heterocycle; a substituted 5 to 10-membered aromatic heterocycle; unsubstituted C₁₋₈alkylsilyl; or substituted C₁₋₈alkylsilyl;
R⁵ is a unsubstituted 5 to 6 membered aromatic heterocycle; or a substituted 5 to 6 membered aromatic heterocycle;
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl;

3. A compounds according to claim 2 characterized in that
X is S or O;
Y is C—H or N;
R¹ is unsubstituted C₃₋₈cycloalkyl; substituted C₃₋₈cycloalkyl; unsubstituted C₆₋₁₀aryl; substituted C₆₋₁₀aryl; unsubstituted C₆₋₁₀aryloxy; substituted C₆₋₁₀aryloxy; a unsubstituted 5 to 10-membered aromatic heterocycle; a substituted 5 to 10-membered aromatic heterocycle;
R² is unsubstituted C₁₋₈alkyl; substituted C₁₋₈alkyl; unsubstituted C₃₋₈cycloalkyl; substituted C₃₋₈cycloalkyl; unsubstituted C₆₋₁₀aryl; substituted C₆₋₁₀aryl; a unsubstituted 5 to 10-membered aromatic heterocycle; a substituted 5 to 10-membered aromatic heterocycle;
R⁵ is a unsubstituted 6 membered aromatic heterocycle comprising one or two nitrogen atoms; or a substituted 6 membered aromatic heterocycle comprising one or two nitrogen atoms;
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; preferably R⁶ and R⁷ are independently H, unsubstituted C₁₋₈alkyl; substituted C₁₋₈alkyl;

4. A compounds according to claim 3 characterized in that
X is S or O;
Y is C—H or N;
R¹ is unsubstituted C₆₋₁₀aryl; substituted C₆₋₁₀aryl;
R² is unsubstituted C₃₋₈cycloalkyl; substituted C₃₋₈cycloalkyl; unsubstituted C₆₋₁₀aryl; substituted C₆₋₁₀aryl;
R⁵ is a unsubstituted pyridyl or pyrimidyl; or a substituted pyridyl or pyrimidyl; preferably a unsubstituted pyridyl or pyrimidyl
R⁶ and R⁷ are independently H, unsubstituted C₁₋₈alkyl; substituted C₁₋₈alkyl; unsubstituted C₂₋₈alkenyl; substituted C₂₋₈alkenyl; unsubstituted C₂₋₈alkinyl; substituted C₂₋₈alkinyl; preferably R⁶ and R⁷ are independently H, methyl, ethyl;

5. A compounds according to claim 4 characterized in that
X is S or O;
Y is C—H or N;
R¹ is unsubstituted phenyl; phenyl substituted by Cl, F;
R² is unsubstituted cyclohexyl; unsubstituted phenyl; phenyl substituted by Cl, F;
R⁵ is unsubstituted pyridyl or pyrimidyl preferably a unsubstituted 3-pyridyl or 5-pyrimidyl
R⁶ and R⁷ are both H

6. A method of preventing and/or controlling fungal infection in plants and/or plant propagation material comprising applying to the plant or plant propagation material or the locus thereof a fungicidally effective amount of a compound of formula (I).

7. A composition for the control of fungal infection comprising a compound of formula (I) and an agriculturally acceptable carrier or diluent.

8. A composition of claim 11, which further comprises at least one additional fungicidally active compound in addition to the compound of formula (I).

9. A composition of claim 8, wherein the additional fungicidally active compound is acibenzolar-S-methyl, azoxystrobin, chlorothalonil, cyproconazole, cyprodinil, difenoconazole, fenpropidin, fluazinam, fludioxonil, hexaconazole, isopyrazam, mandipropamid, mefenoxam, penconazole, propiconazole, pyroquilon, sedaxane or thiabendazole.
